(19) United States
(12) Patent Application Publication
(10) Pub. No.: US 2012/0064601 A1
(43) Pub. Date: Mar. 15, 2012

(54) Chromatography Membranes for the Purification of Chiral Compounds

(76) Inventors: Elena N. Komkova, Hamilton (CA); Amro Ragheb, Mississauga (CA); Charles H. Honeyman, Toronto (CA)

(21) Appl. No.: 13/231,400

(22) Filed: Sep. 13, 2011

Related U.S. Application Data
(60) Provisional application No. 61/382,543, filed on Sep. 14, 2010.

(51) Int. Cl. C12N 9/02; C12N 9/24; C09K 3/00; C12P 41/00; C07B 55/00; C12N 9/00; C12N 9/26

(52) U.S. Cl. 435/189; 435/183; 435/200; 435/201; 435/280; 562/401; 252/184

(57) ABSTRACT

Described herein are composite materials and methods of using them for the separation or purification of enantiomers. In certain embodiments, the composite material comprises a support member, comprising a plurality of pores extending through the support member; and a macroporous cross-linked gel, comprising a plurality of macropores, and a plurality of pendant chiral moieties. In certain embodiments, the composite materials may be used in the separation or purification of a chiral small molecule.

### RELATED APPLICATIONS

This application claims the benefit of priority to U.S. Provisional Patent Application Ser. No. 61/382,543, filed Sep. 14, 2010, the contents of which are hereby incorporated by reference.

### BACKGROUND OF THE INVENTION

Chiral molecules have applications in a variety of industries, including polymers, specialty chemicals, flavors and fragrances, and pharmaceuticals. Many applications in these industries require the use of single enantiomers, as opposed to mixtures of enantiomers. For example, one enantiomer of a chiral drug may perform differently in terms of pharmacological activity, toxicological considerations, or both. Therefore, it is important to be able to obtain enantiomerically-enriched or enantiomerically-pure samples of such compounds. As a general matter, chiral recognition and selection of enantiomers is more demanding than most other forms of chemical interaction and recognition. Enantiomers are difficult to separate because they have broadly identical physical properties, and differ only in their three dimensional geometry by the presence of “mirror image” symmetry. Thus, all aspects of their chemistry appear identical except in a chiral environment (e.g., in the presence of a chiral probe or ligand).

A number of manufacturing, analytical, and preparative procedures have been developed for separation of enantiomers. These include manufacturing procedures, such as asymmetric synthesis and biocatalysis, that produce the desired enantiomers of chiral compounds. Asymmetric synthesis involves the use of libraries of chiral starting molecules to create new molecules of interest, while attempting to preserve their chiral centers. Often a “polishing” chiral resolution or separation step is required to provide a product of acceptable enantiomeric purity. Biocatalysis uses a biocatalyst (e.g., an enzyme or a microorganism) to produce enantiomerically pure compounds. However, matching catalysts and target molecules can be difficult, and the catalytic activity of enzymes decreases over time.

The alternative to enantioselective manufacturing is the isolation or purification of the desired enantiomer from a mixture of enantiomers, usually a racemic mixture. Purification techniques that have been developed for this purpose include crystallization, chiral chromatography, chemical resolution, and membrane chromatography. A widely held theory suggests that three separate binding or contact sites are required per molecule for a chirality-specific ligand or binding interaction to occur. The three-site interaction helps to distinguish between the enantiomers based on the differences in their three-dimensional structures. Indeed, most common chiral selector technologies rely on multi-point interactions between an enantiomeric analyte and, e.g., a chiral ligand.

In some cases of separation by crystallization, a racemate is complexed with another chiral compound that selectively forms a diastereomeric salt with the desired enantiomer, resulting in a chemical distinction between the two enantiomers that allows one preferentially to crystallize in the form of the diastereomeric salt. In other cases, a solution is seeded with crystals of one enantiomer, causing the desired enantiomer preferentially to crystallize. However, this approach works only for the approximately 10% of known compounds that crystallize into distinct enantiopure crystallites.

A second method of separation and purification employs chiral chromatography, such as high performance liquid chromatography (HPLC), which is used in batch mode, or a continuous chromatographic process called simulated moving bed (SMB). The chiral chromatographic materials used in HPLC, SMB, and their supercritical fluid analogs are in many cases the same chiral stationary phases. HPLC tends to be highly engineered and slow, with low capacity and low throughput, employing very small particles of weakly selective, highly chemically specific media. SMB provides higher throughput, but still tends to be highly engineered and costly, with an SMB apparatus typically being designed specifically for each pharmaceutical molecule to be separated at production scale.

However, as a general matter, chiral chromatography has proved to be efficient for a wide range of mixtures of enantiomers and has the potential to be the most efficient because it does not involve the specialized synthesis steps involved in asymmetric synthesis or the additional processing steps involved in chemical resolution, such as salt formation and product recovery from the salt. Further, chiral chromatography is not plagued by the low yields that are typical of crystallization techniques and techniques involving some chiral membranes. The appeal of chiral chromatography has led to the development of a variety of chiral chromatographic techniques based on liquid, gas, subcritical fluid, and supercritical fluid chromatography, with a variety of chiral stationary phases. Chiral chromatographic separations use a large number of chiral stationary phases or chiral materials, where each type of chiral stationary phase material (or chiral selector) has a much higher specificity and lower generality in the types of chiral molecules it can separate. However, there is no simple rule for choosing the chrial selector based on the structure of the compounds to be separated. The choice of the chiral selector is, as a general rule, made empirically, according to the existing data for similar molecules. Additionally, chromatographic methods present scalability challenges, and one method is generally not applicable throughout scale-up from drug discovery to semi-preparative, pilot, and production scale.

Enantioselective-membranes have been explored as an alternative approach to chromatographic methods. Enantioselective membranes may be fabricated by casting membrane-forming solutions containing chiral polymers, such as cellulose or other polysaccharides (chitosan, sodium alginate). For example, an enantioselective membrane using cross-linked sodium alginate and chitosan has been prepared for the optical resolution of α-amino acids, especially tryptophan and tyrosine, by a pressure-driven process. The main disadvantage of this kind of membrane is its low permeability; the low permeability substantially limits the industrial-scale application of this type of enantioselective membrane. This drawback can be partially overcome by using ultrathin optically active polymeric polyelectrolyte “multilayers” coated on a porous substrate. These membranes have high permeation rates due to their thinness and exhibit moderate selectivity. Polypeptides, such as L- and D-poly(lysine), poly(glutamic acid), poly(N-(S)-2-methylbutyl-4-vinyl pyridinium iodide), or poly(styrene sulfonate), can be used as a polyelectrolytes. L- or D-Ascorbic acid (the former is Vitamin C), 3-(3,4-dihydroxyphenyl)-L-/D-alanine (DOPA), and a chiral viologen (a geometric isomer, rather than an enantiomer) have been used as a chiral probes in cast membranes.

In sum, disadvantages of existing methods for obtaining optically pure compounds include high energy consumption, high cost, low efficiency, and discontinuous operation. Therefore, a need exists for an efficient, scalable, inexpensive method by which to separate mixtures of enantiomers, and a material with which to do so.

### SUMMARY OF THE INVENTION

In certain embodiments, the invention relates to a composite material, comprising:

a support member, comprising a plurality of pores extending through the support member; and

a macroporous cross-linked gel, comprising a plurality of macropores, and a plurality of pendant chiral moieties;

wherein the macroporous cross-linked gel is located in the pores of the support member; and the average pore diameter of the macropores is less than the average pore diameter of the pores.

In certain embodiments, the invention relates to a method, comprising the step of:

contacting, at a first flow rate, a first fluid with any one of the aforementioned composite materials, wherein said first fluid comprises a first mixture of stereoisomers of a compound; said first mixture consists of a first enantiomer and a second enantiomer; the first enantiomer and the second enantiomer are enantiomers of each other; and the rate of passage of the second enantiomer through the composite material is greater than the rate of passage of the first enantiomer through the composite material, thereby producing a second mixture of stereoisomers of the compound.

In certain embodiments, the invention relates to a method, comprising the steps of:

contacting, at a first flow rate, a first fluid with any one of the aforementioned composite materials, wherein said first fluid comprises a first mixture of stereoisomers of a compound; said first mixture consists of a first enantiomer and a second enantiomer; the first enantiomer and the second enantiomer are enantiomers of each other; and the rate of passage of the second enantiomer through the composite material is greater than the rate of passage of the first enantiomer through the composite material, thereby producing a second mixture of stereoisomers of the compound; and

contacting the second mixture of stereoisomers of the compound with a second of the aforementioned composite materials, wherein the first composite material and the second composite material are different, thereby producing a third mixture of stereoisomers of the compound.

In certain embodiments, the invention relates to a method, comprising the step of:

contacting, at a first flow rate, a first fluid with any one of the aforementioned composite materials, wherein said first fluid comprises a first mixture of stereoisomers of a compound; said first mixture consists of a first enantiomer and a second enantiomer; the first enantiomer and the second enantiomer are enantiomers of each other; and the first enantiomer is adsorbed or absorbed onto the composite material, thereby producing a first permeate comprising the second enantiomer.

### BRIEF DESCRIPTION OF THE FIGURES

FIG. 1 tabulates various chiral proteins that may be used in embodiments of the invention.

FIG. 2 tabulates various chiral selectors of the invention, and examples of enantiomeric compounds that may be separated by each of them.

FIG. 3 tabulates various chiral selectors of the invention, and examples of enantiomeric compounds that may be separated by each of them.

FIG. 4 depicts a representative chromatogram obtained from the injection of racemic ibuprofen onto an HSA NHS-membrane at flow rate of 1 mL/min.

FIG. 5 depicts a representative chromatogram obtained from the injection of racemic ibuprofen onto a quinidine-based membrane.

FIG. 6 tabulates certain chromatographic parameters for a number of separations of racemic ibuprofen on exemplary inventive chiral membranes.

FIG. 7 depicts a representative chromatogram obtained from the injection of racemic ketoprofen onto an HSA-based membrane (sharp peak at ˜1 minute attributed to excess analyte).

FIG. 8 depicts a CD spectrum as a function of time of the effluent from an injection of racemic ketoprofen on an HSA-membrane in sodium phosphate buffer/iso-propanol.

FIG. 9 depicts a representative chromatogram obtained from the injection of racemic ketoprofen onto an HSA-based membrane at 1 mL/min.

FIG. 10 depicts a representative chromatogram obtained from the injection of racemic ibuprofen onto a quinidine-based membrane at 1 mL/min.

FIG. 11 depicts a representative chromatogram obtained from the injection of racemic atenolol onto a β-CD-based membrane at 1 mL/min.

FIG. 12 depicts a representative chromatogram obtained from the injection of racemic atenolol and S-atenolol, separately, onto a β-CD-based membrane at 1 mL/min.

FIG. 13 depicts a representative chromatogram obtained from the injection of racemic ketoprofen onto a quinidine-based membrane at 1.5 mL/min.

FIG. 14 depicts a representative chromatogram obtained from the injection of racemic ketoprofen and S-ketoprofen, separately, onto a quinidine-based membrane at 1.5 mL/min.

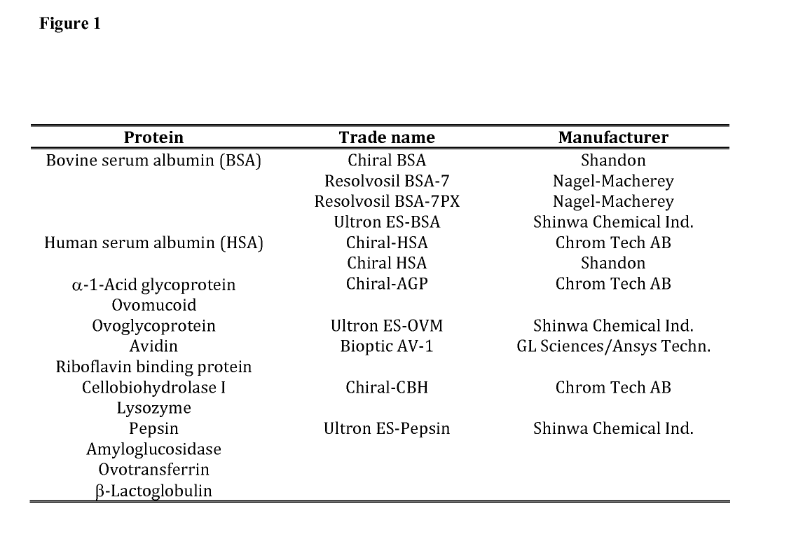

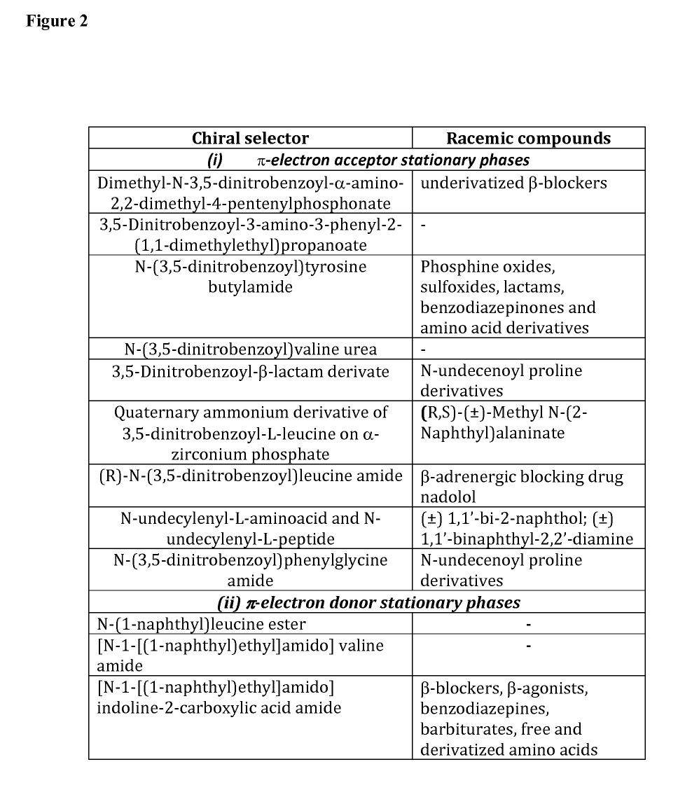

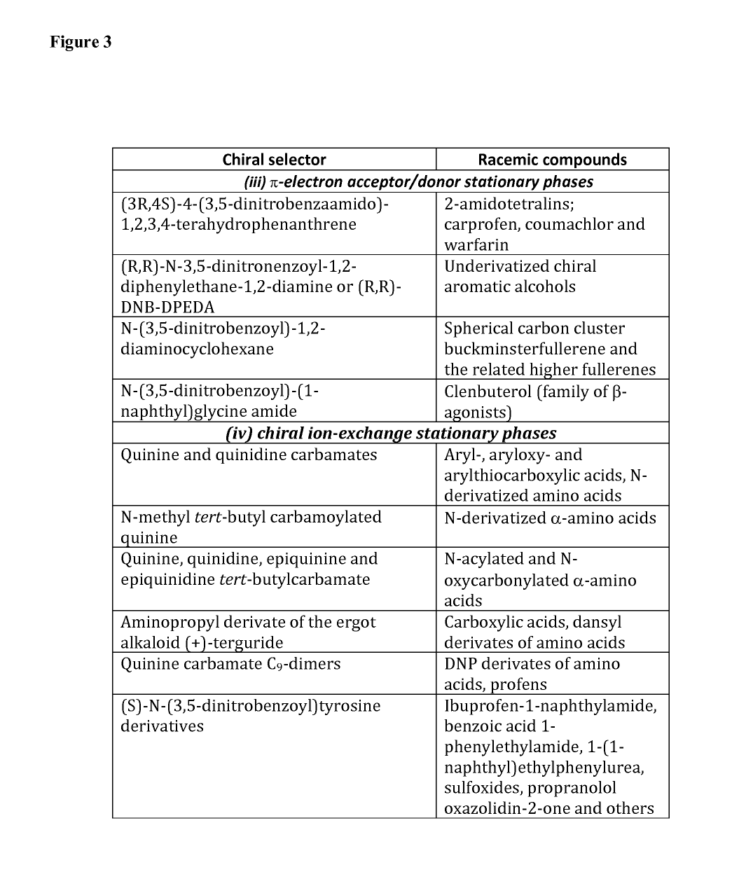

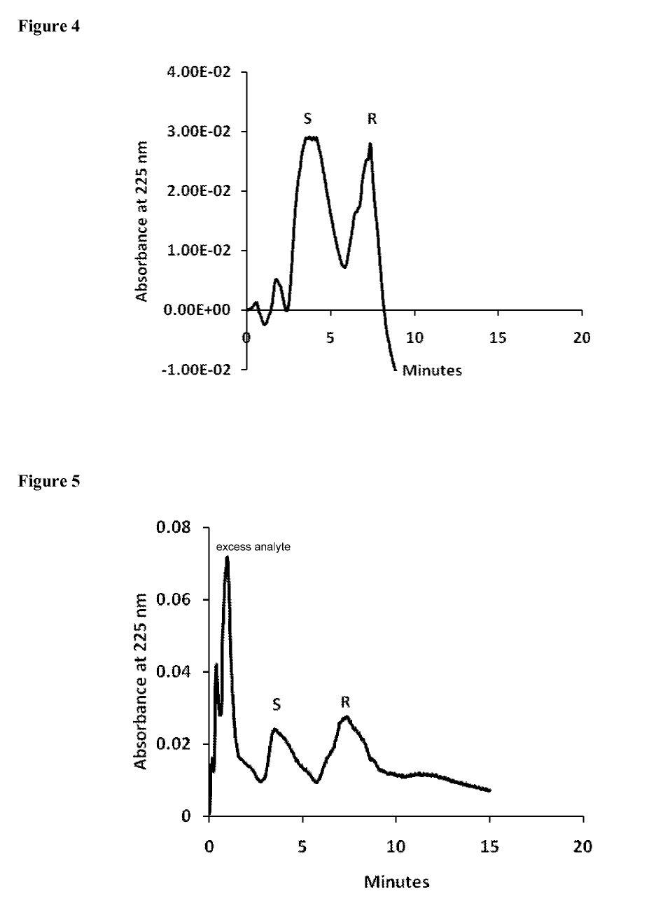

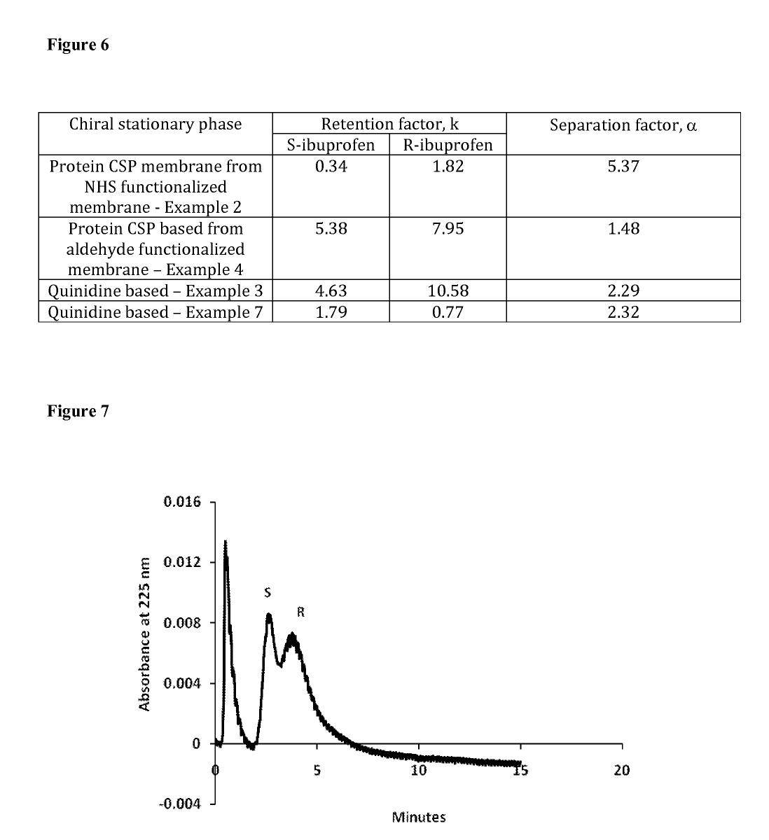

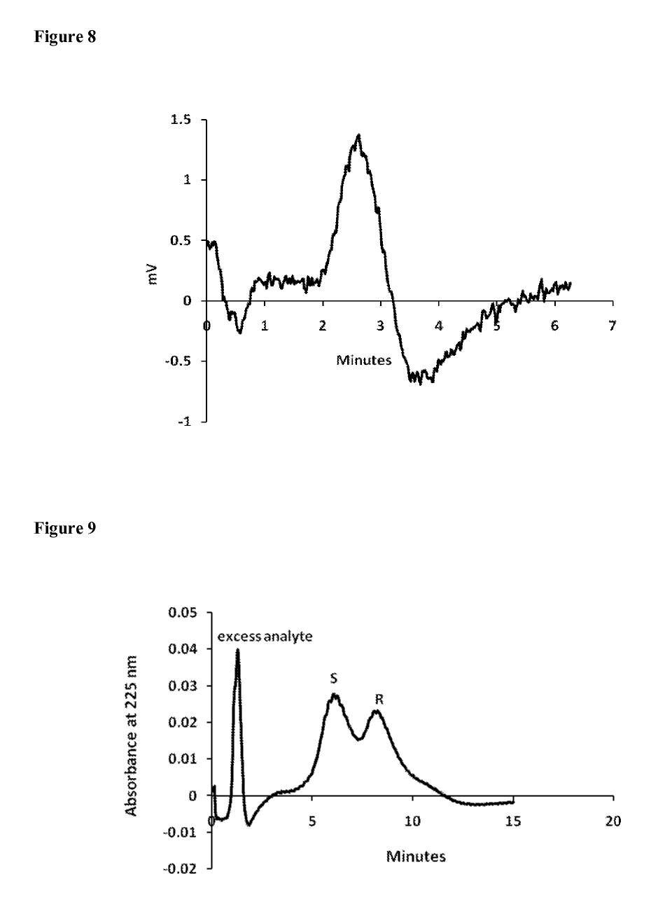

### DETAILED DESCRIPTION OF THE INVENTION

### Overview

The constantly increasing need for single enantiomers as key intermediates in the chemical and pharmaceutical industry has stimulated a significant demand for efficient processes to resolve mixtures of enantiomers (e.g., racemic mixtures). In the context of potential industrial applications, the focus is on technologies allowing enantioseparation in continuous fashion. However, the field is confronted with a number of technical limitations (e.g., those enumerated in the Background). Many of these limitations can be minimized by using membranes and membrane processes. In certain embodiments, membrane separation processes are well-suited for large-scale applications because they combine the following attractive features: low-energy consumption, large processing capacity, low cost, high efficiency, simplicity, continuous operation mode, easy adaptation to a range of production-relevant process configurations, convenient up-scaling, high flux, and, in most cases, ambient temperature processing.

In certain embodiments, the invention relates to the purification or separation of a chiral compound based on differences in three-dimensional structure. In certain embodiments, chiral compounds may be selectively purified in a single step. In certain embodiments, the composite materials demonstrate exceptional performance in comparison to commercially available chromatographic materials or known membranes for separating enantiomers. In certain embodiments, the composite materials demonstrate comparable performance at higher flow rates than can be achieved with commercially available chromatographic materials or known membranes for separating enantiomers.

In certain embodiments, the invention relates to a composite material comprising a macroporous gel within a porous support member. The composite materials are suited for the removal or purification of chiral solutes, such as small molecules. In certain embodiments, the invention relates to a composite material that is simple, versatile, and inexpensive to produce.

In certain embodiments, the composite material is an enantioselective membrane, wherein the enantioselective membrane comprises a chiral selector or a chiral-derived polymer. In certain embodiments, the chiral selector is carried or immobilized in the composite material. In certain embodiments, the membrane is fairly stable; therefore, a durable separation process for enantiomers is possible.

In certain embodiments, membrane processes for the separation of enantiomers may be categorized as sorption-selective processes. In certain embodiments, sorption selective processes utilize a membrane with an immobilized chiral selector. In certain embodiments, when utilizing sorption-selective membranes the interaction between the chiral selectors immobilized on the membrane and the enantiomers accounts for the separation. In certain embodiments, the invention relates to a method of separating or purifying enantiomers from solution based on a preferential interaction the pendant chiral moiety on the composite material has with one enantiomer. In certain embodiments, by tailoring the conditions for fractionation, selectivity can be obtained.

In certain embodiments, the invention relates to a method of reversible adsorption of a substance. In these cases, membrane processes for the separation of enantiomers might be categorized as sorption-specific processes. In certain embodiments, these processes utilize a composite material with a binding constant for one enantiomer that is significantly higher than the binding constant for the other enantiomer; therefore, processes may be run in “capture and release” or “bind and elute” mode. In certain embodiments, these processes resemble filtrations (e.g., more so than typical chromatographic methods).

In certain embodiments, an adsorbed substance may be released by changing the liquid that flows through the macroporous gel of the composite material. In certain embodiments, the uptake and release of substances may be controlled by variations in the composition of the macroporous cross-linked gel.

### Various Characteristics of Exemplary Composite Materials

### Composition of the Macroporous Gels

In certain embodiments, the macroporous gels may be formed through the in situ reaction of one or more polymerizable monomers with one or more cross-linkers. In certain embodiments, the macroporous gels may be formed through the reaction of one or more cross-linkable polymers with one or more cross-linkers. In certain embodiments, a cross-linked gel having macropores of a suitable size may be formed.

In certain embodiments, suitable polymerizable monomers include monomers containing vinyl or acryl groups. In certain embodiments, polymerizable monomers is selected from the group consisting of acrylamide, N-acryloxysuccinimide, butyl acrylate and methacrylate, N,N-diethylacrylamide, N,N-dimethylacrylamide, 2-(N,N-dimethylamino)ethyl acrylate and methacrylate, N-[3-(N,N-dimethylamino)propyl]methacrylamide, N,N-dimethylacrylamide, n-dodecyl acrylate, n-dodecyl methacrylate, phenyl acrylate and methacrylate, dodecyl methacrylamide, ethyl acrylate and methacrylate, 2-ethylhexyl methacrylate, hydroxypropyl methacrylate, glycidyl acrylate and methacrylate, ethylene glycol phenyl ether methacrylate, n-heptyl acrylate and methacrylate, 1-hexadecyl acrylate and methacrylate, methacrylamide, methacrylic anhydride, octadecyl acrylamide, octylacrylamide, octyl methacrylate, propyl acrylate and methacrylate, N-iso-propylacrylamide, stearyl acrylate and methacrylate, styrene, alkylated styrene derivatives, 4-vinylpyridine, vinylsulfonic acid, and N-vinyl-2-pyrrolidinone (VP). In certain embodiments, the polymerizable monomers may comprise butyl, hexyl, phenyl, ether, or polypropylene glycol) side chains. In certain embodiments, various other vinyl or acryl monomers comprising a reactive functional group may be used; these reactive monomers may be subsequently functionalized with a chiral moiety.

In certain embodiments, the monomer may comprise a reactive functional group. In certain embodiments, the reactive functional group of the monomer may be reacted with any of a variety of specific ligands. In certain embodiments, the reactive functional group of the monomer may be reacted with a chiral moiety. In certain embodiments, this technique allows for partial or complete control of ligand density or pore size. In certain embodiments, the reactive functional group of the monomer may be functionalized prior to the gel-forming reaction. In certain embodiments, the reactive functional group of the monomer may be functionalized subsequent to the gel-forming reaction. For example, if the monomer is glycidyl methacrylate, the epoxide functionality of the monomer may be reacted with a chiral selector, such as a chiral primary amine, to introduce chiral functionality into the resultant polymer. In certain embodiments, monomers, such as glycidyl methacrylate, acrylamidoxime, acrylic anhydride, azelaic anhydride, maleic anhydride, hydrazide, acryloyl chloride, 2-bromoethyl methacrylate, or vinyl methyl ketone, may be further functionalized.

In certain embodiments, the cross-linking agent may be a compound containing at least two vinyl or acryl groups. In certain embodiments, the cross-linking agent is selected from the group consisting of bisacrylamidoacetic acid, 2,2-bis[4-(2-acryloxyethoxy)phenyl]propane, 2,2-bis(4-methacryloxyphenyl)propane, butanediol diacrylate and dimethacrylate, 1,4-butanediol divinyl ether, 1,4-cyclohexanediol diacrylate and dimethacrylate, 1,10-dodecanediol diacrylate and dimethacrylate, 1,4-diacryloylpiperazine, diallylphthalate, 2,2-dimethylpropanediol diacrylate and dimethacrylate, dipentaerythritol pentaacrylate, dipropylene glycol diacrylate and dimethacrylate, N,N-dodecamethylenebisacrylamide, divinylbenzene, glycerol trimethacrylate, glycerol tris(acryloxypropyl) ether, N,N′-hexamethylenebisacrylamide, N,N′-octamethylenebisacrylamide, 1,5-pentanediol diacrylate and dimethacrylate, 1,3-phenylenediacrylate, poly(ethylene glycol) diacrylate and dimethacrylate, poly(propylene) diacrylate and dimethacrylate, triethylene glycol diacrylate and dimethacrylate, triethylene glycol divinyl ether, tripropylene glycol diacrylate or dimethacrylate, diallyl diglycol carbonate, poly(ethylene glycol) divinyl ether, N,N′-dimethacryloylpiperazine, divinyl glycol, ethylene glycol diacrylate, ethylene glycol dimethacrylate, N,N′ -methylenebisacrylamide, 1,1,1-trimethylolethane trimethacrylate, 1,1,1-trimethylolpropane triacrylate, 1,1,1-trimethylolpropane trimethacrylate (TRIM-M), vinyl acrylate, 1,6-hexanediol diacrylate and dimethacrylate, 1,3-butylene glycol diacrylate and dimethacrylate, alkoxylated cyclohexane dimethanol diacrylate, alkoxylated hexanediol diacrylate, alkoxylated neopentyl glycol diacrylate, aromatic dimethacrylate, caprolactone modified neopentylglycol hydroxypivalate diacrylate, cyclohexane dimethanol diacrylate and dimethacrylate, ethoxylated bisphenol diacrylate and dimethacrylate, neopentyl glycol diacrylate and dimethacrylate, ethoxylated trimethylolpropane triacrylate, propoxylated trimethylolpropane triacrylate, propoxylated glyceryl triacrylate, pentaerythritol triacrylate, tris (2-hydroxy ethyl)isocyanurate triacrylate, di-trimethylolpropane tetraacrylate, dipentaerythritol pentaacrylate, ethoxylated pentaerythritol tetraacrylate, pentaacrylate ester, pentaerythritol tetraacrylate, caprolactone modified dipentaerythritol hexaacrylate, N,N′-methylenebisacrylamide, diethylene glycol diacrylate and dimethacrylate, trimethylolpropane triacrylate, ethylene glycol diacrylate and dimethacrylate, tetra(ethylene glycol) diacrylate, 1,6-hexanediol diacrylate, divinylbenzene, and poly(ethylene glycol) diacrylate.

In certain embodiments, the size of the macropores in the resulting gel increases as the concentration of cross-linking agent is increased. In certain embodiments, the mole percent (mol %) of cross-linking agent to monomer(s) may be about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

In certain embodiments, the properties of the composite materials may be tuned by adjusting the average pore diameter of the macroporous gel. The size of the macropores is generally dependent on the nature and concentration of the cross-linking agent, the nature of the solvent or solvents in which the gel is formed, the amount of any polymerization initiator or catalyst and, if present, the nature and concentration of porogen. In certain embodiments, the composite material may have a narrow pore-size distribution.

### Porous Support Member

In some embodiments, the porous support member is made of polymeric material and contains pores of average size between about 0.1 and about 25 μm, and a volume porosity between about 40% and about 90%. Many porous substrates or membranes can be used as the support member but the support may be a polymeric material. In certain embodiments, the support may be a polyolefin, which is available at low cost. In certain embodiments, the polyolefin may be poly(ethylene), poly(propylene), or poly(vinylidene difluoride). Extended polyolefin membranes made by thermally induced phase separation (TIPS) or non-solvent induced phase separation are mentioned. In certain embodiments, the support member may be made from natural polymers, such as cellulose or its derivatives. In certain embodiments, suitable supports include polyethersulfone membranes, poly(tetrafluoroethylene) membranes, nylon membranes, cellulose ester membranes, or filter papers.

In certain embodiments, the porous support is composed of woven or non-woven fibrous material, for example, a polyolefin such as polypropylene. Such fibrous woven or non-woven support members can have pore sizes larger than the TIPS support members, in some instances up to about 75 μm. The larger pores in the support member permit formation of composite materials having larger macropores in the macroporous gel. Non-polymeric support members can also be used, such as ceramic-based supports. In certain embodiments, the support member is fiberglass. The porous support member can take various shapes and sizes.

In some embodiments, the support member is in the form of a membrane that has a thickness from about 10 to about 2000 μm, from about 10 to about 1000 μm, or from about 10 to about 500 μm. In other embodiments, multiple porous support units can be combined, for example, by stacking In one embodiment, a stack of porous support membranes, for example, from 2 to 10 membranes, can be assembled before the macroporous gel is formed within the void of the porous support. In another embodiment, single support member units are used to form composite material membranes, which are then stacked before use.

### Relationship Between Macroporous Gel And Support Member

The macroporous gel may be anchored within the support member. The term “anchored” is intended to mean that the gel is held within the pores of the support member, but the term is not necessarily restricted to mean that the gel is chemically bound to the pores of the support member. The gel can be held by the physical constraint imposed upon it by enmeshing and intertwining with structural elements of the support member, without actually being chemically grafted to the support member, although in some embodiments, the macroporous gel may be grafted to the surface of the pores of the support member.

Because the macropores are present in the gel that occupies the pores of the support member, the macropores of the gel must be smaller than the pores of the support member. Consequently, the flow characteristics and separation characteristics of the composite material are dependent on the characteristics of the macroporous gel, but are largely independent of the characteristics of the porous support member, with the proviso that the size of the pores present in the support member is greater than the size of the macropores of the gel. The porosity of the composite material can be tailored by filling the support member with a gel whose porosity is partially or completely dictated by the nature and amounts of monomer or polymer, cross-linking agent, reaction solvent, and any porogen, if used. As pores of the support member are filled with the same macroporous gel material, a high degree of consistency is achieved in properties of the composite material, and for a particular support member these properties are determined partially, if not entirely, by the properties of the macroporous gel. The net result is that the invention provides control over macropore size, permeability and surface area of the composite materials.

The number of macropores in the composite material is not dictated by the number of pores in the support material. The number of macropores in the composite material can be much greater than the number of pores in the support member because the macropores are smaller than the pores in the support member. As mentioned above, the effect of the pore-size of the support material on the pore-size of the macroporous gel is generally negligible. An exception is found in those cases where the support member has a large difference in pore-size and pore-size distribution, and where a macroporous gel having very small pore-sizes and a narrow range in pore-size distribution is sought. In these cases, large variations in the pore-size distribution of the support member are weakly reflected in the pore-size distribution of the macroporous gel. In certain embodiments, a support member with a somewhat narrow pore-size range may be used in these situations.

### Preparation of Composite Materials

In certain embodiments, the composite materials of the invention may be prepared by single-step methods. In certain embodiments, these methods may use water or other environmentally benign solvents as the reaction solvent. In certain embodiments, the methods may be rapid and, therefore, may lead to easier manufacturing processes. In certain embodiments, preparation of the composite materials may be inexpensive.

In certain embodiments, the composite materials of the invention may be prepared by mixing one or more monomers, one or more cross-linking agents, one or more initiators, and optionally one or more porogens, in one or more suitable solvents. In certain embodiments, the resulting mixture may be homogeneous. In certain embodiments, the mixture may be heterogeneous. In certain embodiments, the mixture may then be introduced into a suitable porous support, where a gel forming reaction may take place.

In certain embodiments, suitable solvents for the gel-forming reaction include 1,3-butanediol, di(propylene glycol) propyl ether, N,N-dimethylacetamide, di(propylene glycol) methyl ether acetate (DPMA), water, dioxane, dimethylsulfoxide (DMSO), dimethylformamide (DMF), acetone, ethanol, N-methylpyrrolidone (NMP), tetrahydrofuran (THF), ethyl acetate, acetonitrile, toluene, xylenes, hexane, N-methylacetamide, propanol, methanol, or mixtures thereof. In certain embodiments, solvents that have a higher boiling point may be used, as these solvents reduce flammability and facilitate manufacture. In certain embodiments, solvents that have a low toxicity may be used, so they may be disposed readily after use. An example of such a solvent is dipropyleneglycol monomethyl ether (DPM).

In certain embodiments, a porogen may be added to the reactant mixture, wherein porogens may be broadly described as pore-generating additives. In certain embodiments, the porogen is selected from the group consisting of poor solvents and extractable polymers, for example, poly(ethyleneglycol), surfactants, and salts.

In some embodiments, components of the gel forming reaction react spontaneously at room temperature to form the macroporous gel. In other embodiments, the gel forming reaction must be initiated. In certain embodiments, the gel forming reaction may be initiated by any known method, for example, through thermal activation or UV radiation. In certain embodiments, the reaction may be initiated by UV radiation in the presence of a photoinitiator. In certain embodiments, the photoinitiator is selected from the group consisting of 2-hydroxy-1-[4-2(hydroxyethoxy)phenyl]-2-methyl-1-propanone (Irgacure 2959), 2,2-dimethoxy-2-phenylacetophenone (DMPA), benzophenone, benzoin and benzoin ethers, such as benzoin ethyl ether and benzoin methyl ether, dialkoxyacetophenones, hydroxyalkylphenones, and α-hydroxymethyl benzoin sulfonic esters. Thermal activation may require the addition of a thermal initiator. In certain embodiments, the thermal initiator is selected from the group consisting of 1,1′-azobis(cyclohexanecarbonitrile) (VAZO® catalyst 88), azobis(isobutyronitrile) (AIBN), potassium persulfate, ammonium persulfate, and benzoyl peroxide.

In certain embodiments, the gel-forming reaction may be initiated by UV radiation. In certain embodiments, a photoinitiator may be added to the reactants of the gel forming reaction, and the support member containing the mixture of monomer, cross-linking agent, and photoinitiator may be exposed to UV radiation at wavelengths from about 250 nm to about 400 nm for a period of a few seconds to a few hours. In certain embodiments, the support member containing the mixture of monomer, cross-linking agent, and photoinitiator may be exposed to UV radiation at about 350 nm for a period of a few seconds to a few hours. In certain embodiments, the support member containing the mixture of monomer, cross-linking agent, and photoinitiator may be exposed to UV radiation at about 350 nm for about 10 minutes. In certain embodiments, visible wavelength light may be used to initiate the polymerization. In certain embodiments, the support member must have a low absorbance at the wavelength used so that the energy may be transmitted through the support member.

In certain embodiments, the rate at which polymerization is carried out may have an effect on the size of the macropores obtained in the macroporous gel. In certain embodiments, when the concentration of cross-linker in a gel is increased to sufficient concentration, the constituents of the gel begin to aggregate to produce regions of high polymer density and regions with little or no polymer, which latter regions are referred to as “macropores” in the present specification. This mechanism is affected by the rate of polymerization. In certain embodiments, the polymerization may be carried out slowly, such as when a low light intensity in the photopolymerization is used. In this instance, the aggregation of the gel constituents has more time to take place, which leads to larger pores in the gel. In certain embodiments, the polymerization may be carried out at a high rate, such as when a high intensity light source is used. In this instance, there may be less time available for aggregation and smaller pores are produced.

In certain embodiments, once the composite materials are prepared they may be washed with various solvents to remove any unreacted components and any polymer or oligomers that are not anchored within the support. In certain embodiments, solvents suitable for the washing the composite material include water, acetone, methanol, ethanol, N,N-dimethylacetamide, pyridine, and DMF.

### Exemplary Composite Materials

In certain embodiments, the invention relates to a composite material, comprising:

a support member, comprising a plurality of pores extending through the support member; and

a macroporous cross-linked gel, comprising a plurality of macropores, and a plurality of pendant chiral moieties;

wherein the macroporous cross-linked gel is located in the pores of the support member; and the average pore diameter of the macropores is less than the average pore diameter of the pores.

In certain embodiments, the invention relates to any one of the aforementioned composite materials, wherein the macroporous cross-linked gel comprises a polymer derived from acrylamide, N-acryloxysuccinimide, butyl acrylate or methacrylate, N,N-diethylacrylamide, N,N-dimethylacrylamide, 2-(N,N-dimethylamino)ethyl acrylate or methacrylate, 2-(N,N-diethylamino)ethyl acrylate or methacrylate N-[3-(N,N-dimethylamino)propyl]methacrylamide, N,N-dimethylacrylamide, n-dodecyl acrylate, n-dodecyl methacrylate, phenyl acrylate or methacrylate, dodecyl methacrylamide, ethyl acrylate or methacrylate, 2-ethylhexyl acrylate or methacrylate, hydroxypropyl acrylate or methacrylate, glycidyl acrylate or methacrylate, ethylene glycol phenyl ether methacrylate, n-heptyl acrylate or methacrylate, 1-hexadecyl acrylate or methacrylate, methacrylamide, methacrylic anhydride, octadecyl acrylamide, octylacrylamide, octyl acrylate or methacrylate, propyl acrylate or methacrylate, N-iso-propylacrylamide, stearyl acrylate or methacrylate, styrene, alkylated styrene derivatives, 4-vinylpyridine, vinylsulfonic acid, N-vinyl-2-pyrrolidinone (VP), acrylamido-2-methyl-1-propanesulfonic acid, styrenesulfonic acid, alginic acid, (3-acrylamidopropyl)trimethylammonium halide, diallyldimethylammonium halide, 4-vinyl-N-methylpyridinium halide, vinylbenzyl-N-trimethylammonium halide, methacryloxyethyltrimethylammonium halide, or 2-(2-methoxy)ethyl acrylate or methacrylate. In certain embodiments, the halide is chloride, bromide, or iodide.

In certain embodiments, the invention relates to any one of the aforementioned composite materials, wherein the macroporous cross-linked gel comprises a polymer derived from acrylamide, butyl acrylate or methacrylate, ethyl acrylate or methacrylate, 2-ethylhexyl methacrylate, hydroxypropyl acrylate or methacrylate, hydroxyethyl acrylate or methacrylate, hydroxymethyl acrylate or methacrylate, glycidyl acrylate or methacrylate, propyl acrylate or methacrylate, or N-vinyl-2-pyrrolidinone (VP).

In certain embodiments, the invention relates to any one of the aforementioned composite materials, wherein the pendant chiral moieties are proteins or small molecules.

In certain embodiments, the invention relates to any one of the aforementioned composite materials, wherein the pendant chiral moieties are proteins selected from the group consisting of α₁-acid glucoprotein, α-1-acid glycoprotein, albumins, amino acid oxidase apoenzyme, amyloglucosidase, antibodies, avidin, bovine serum albumin, cellobiohydrolase I, cellulose, α-chymotrypsin, DNA, DNA-cellulose, DNA-chitosan, enzymes, glucoproteins, human serum albumin, β-lactoglobulin, lysozyme, ovoglycoprotein, ovomucoid, ovotransferrin, pepsin, riboflavin binding protein, and trypsin.

In certain embodiments, the invention relates to any one of the aforementioned composite materials, wherein the pendant chiral moieties are human serum albumin molecules.

In certain embodiments, the invention relates to any one of the aforementioned composite materials, wherein the pendant chiral moieties are small molecules selected from the group consisting of a single enantiomer of: an aminopropyl derivative of the ergot alkaloid terguride, copper(II) N-decyl-hydroxyproline, a cyclodextrin, a deoxycholic acid derivative, di-n-dodecyltartrate, an N,N-dimethyl carbamate of a cinchona alkaloid, dimethyl-N-3,5-dinitrobenzoyl-α-amino-2,2-dimethyl-4-pentenylphosphonate, 4-(3,5-dinitrobenzaamido)-1,2,3,4-terahydrophenanthrene, N-3,5-dinitrobenzoyl-alanine-octylester, 3,5-dinitrobenzoyl-3-amino-3-phenyl-2-(1,1-dimethylethyl)propanoate, N-(3,5 -dinitrobenzoyl)-1,2-diaminocyclohexane, N-3,5-dinitrobenzoyl-1,2-diphenylethane-1,2-diamine, a 3,5-dinitrobenzoyl-β-lactam derivative, a quaternary ammonium derivative of 3,5-dinitrobenzoyl-leucine, N-(3,5-dinitrobenzoyl)leucine, N-(3,5-dinitrobenzoyl)leucine amide, N-(3,5-dinitrobenzoyl)-(1-naphthyl)glycine amide, N-3,5-dinitrobenzoyl-phenylalanine-octylester, N-(3,5-dinitrobenzoyl)phenylglycine amide, N-(3,5-dinitrobenzoyl)tyrosine butylamide, a N-(3,5-dinitrobenzoyl)tyrosine derivative, N-(3,5-dinitrobenzoyl)valine urea, a N,N-diphenyl carbamate of a chinchona alkaloid, DNB-diphenylethanediamine, N-dodecyl-4-hydroxyproline, epiquinidine tert-butylcarbamate, epiquinine, N-hexadecyl hydroxyproline, N-methyl tent-butyl carbamoylated quinine, a N-methyl-N-phenyl carbamate of a cinchona alkaloid, [N-1-[(1-naphthyl)ethyl]amido] indoline-2-carboxylic acid amide, [N-1-[(1-naphthyl)ethyl]amido] valine amide, a N-(1-naphthyl)leucine ester, N-(1-naphthyl)leucine octadecyl ester, a N-phenyl carbamate of a cinchona alkaloid, quinidine, a quinidine carbamate, quinine, a quinine carbamate, a quinine carbamate C₉-dimer, an N-undecylenyl-amino acid, and an N-undecylenyl-peptide.

In certain embodiments, the invention relates to any one of the aforementioned composite materials, wherein the pendant chiral moieties are small molecules selected from the group consisting of: a calix[n]arene and a crown ether.

In certain embodiments, the invention relates to any one of the aforementioned composite materials, wherein the pendant chiral moieties are α₁-acid glucoprotein molecules.

In certain embodiments, the invention relates to any one of the aforementioned composite materials, wherein the pendant chiral moieties are an aminopropyl derivative of the ergot alkaloid (+)-terguride.

In certain embodiments, the invention relates to any one of the aforementioned composite materials, wherein the pendant chiral moieties are β-cyclodextrin molecules.

In certain embodiments, the invention relates to any one of the aforementioned composite materials, wherein the pendant chiral moieties are L-di-n-dodecyltartrate molecules.

In certain embodiments, the invention relates to any one of the aforementioned composite materials, wherein the pendant chiral moieties are N-3,5-dinitrobenzoyl-L-alanine-octylester molecules.

In certain embodiments, the invention relates to any one of the aforementioned composite materials, wherein the pendant chiral moieties are dimethyl-N-3,5-dinitrobenzoyl-α-amino-2,2-dimethyl-4-pentenylphosphonate molecules.

In certain embodiments, the invention relates to any one of the aforementioned composite materials, wherein the pendant chiral moieties are (3R,4S)-4-(3,5-dinitrobenzaamido)-1,2,3,4-terahydrophenanthrene molecules.

In certain embodiments, the invention relates to any one of the aforementioned composite materials, wherein the pendant chiral moieties are N-(3,5-dinitrobenzoyl)-1,2-diaminocyclohexane molecules.

In certain embodiments, the invention relates to any one of the aforementioned composite materials, wherein the pendant chiral moieties are (R,R)-N-3,5-dinitrobenzoyl-1,2-diphenylethane-1,2-diamine molecules or (R,R)-DNB-diphenylethanediamine molecules.

In certain embodiments, the invention relates to any one of the aforementioned composite materials, wherein the pendant chiral moieties are 3,5-dinitrobenzoyl-β-lactam derivatives.

In certain embodiments, the invention relates to any one of the aforementioned composite materials, wherein the pendant chiral moieties are quaternary ammonium derivatives of 3,5-dinitrobenzoyl-leucine.

In certain embodiments, the invention relates to any one of the aforementioned composite materials, wherein the pendant chiral moieties are (R)-N-(3,5-dinitrobenzoyl)leucine amide molecules.

In certain embodiments, the invention relates to any one of the aforementioned composite materials, wherein the pendant chiral moieties are N-(3,5-dinitrobenzoyl)-(1-naphthyl)glycine amide molecules.

In certain embodiments, the invention relates to any one of the aforementioned composite materials, wherein the pendant chiral moieties are N-(3,5-dinitrobenzoyl)phenylglycine amide molecules.

In certain embodiments, the invention relates to any one of the aforementioned composite materials, wherein the pendant chiral moieties are N-(3,5-dinitrobenzoyl)tyrosine butylamide molecules.

In certain embodiments, the invention relates to any one of the aforementioned composite materials, wherein the pendant chiral moieties are (S)-N-(3,5-dinitrobenzoyl)tyrosine derivatives.

In certain embodiments, the invention relates to any one of the aforementioned composite materials, wherein the pendant chiral moieties are N-dodecyl-4(R)-hydroxyl-L-proline molecules.

In certain embodiments, the invention relates to any one of the aforementioned composite materials, wherein the pendant chiral moieties are N-hexadecyl-L-hydroxyproline molecules.

In certain embodiments, the invention relates to any one of the aforementioned composite materials, wherein the pendant chiral moieties are N-methyl tent-butyl carbamoylated quinine molecules.

In certain embodiments, the invention relates to any one of the aforementioned composite materials, wherein the pendant chiral moieties are [N-1-[(1-naphthyl)ethyl]amido] indoline-2-carboxylic acid amide molecules.

In certain embodiments, the invention relates to any one of the aforementioned composite materials, wherein the pendant chiral moieties are quinine derivatives or quinidine derivatives.

In certain embodiments, the invention relates to any one of the aforementioned composite materials, wherein the pendant chiral moieties are quinidine molecules, quinine molecules, epiquinine molecules, or epiquinidine tert-butylcarbamate molecules.

In certain embodiments, the invention relates to any one of the aforementioned composite materials, wherein the pendant chiral moieties are quinidine derivatives or quinidine molecules.

In certain embodiments, the invention relates to any one of the aforementioned composite materials, wherein the pendant chiral moieties are quinine carbamate C₉-dimer molecules.

In certain embodiments, the invention relates to any one of the aforementioned composite materials, wherein the pendant chiral moieties are quinine carbamates or quinidine carbamates.

In certain embodiments, the invention relates to any one of the aforementioned composite materials, wherein the pendant chiral moieties are N-undecylenyl-L-aminoacid molecules or N-undecylenyl-L-peptide molecules.

In certain embodiments, the invention relates to any one of the aforementioned composite materials, wherein the macroporous cross-linked gel has a volume porosity from about 30% to about 80%; and the macropores have an average pore diameter from about 10 nm to about 3000 nm.

In certain embodiments, the invention relates to any one of the aforementioned composite materials, wherein the macroporous cross-linked gel has a volume porosity from about 40% to about 70%. In certain embodiments, the invention relates to any one of the aforementioned composite materials, wherein the macroporous cross-linked gel has a volume porosity of about 40%, about 45%, about 50%, about 55%, about 60%, about 65%, or about 70%.

In certain embodiments, the invention relates to any one of the aforementioned composite materials, wherein the average pore diameter of the macropores is about 25 nm to about 1000 nm.

In certain embodiments, the invention relates to any one of the aforementioned composite materials, wherein the average pore diameter of the macropores is about 50 nm to about 500 nm. In certain embodiments, the invention relates to any one of the aforementioned composite materials, wherein the average pore diameter of the macropores is about 50 nm, about 100 nm, about 150 nm, about 200 nm, about 250 nm, about 300 nm, about 350 nm, about 400 nm, about 450 nm, or about 500 nm.

In certain embodiments, the invention relates to any one of the aforementioned composite materials, wherein the average pore diameter of the macropores is from about 200 nm to about 300 nm. In certain embodiments, the invention relates to any one of the aforementioned composite materials, wherein the average pore diameter of the macropores is from about 75 nm to about 150 nm.

In certain embodiments, the invention relates to any one of the aforementioned composite materials, wherein the composite material is a membrane.

In certain embodiments, the invention relates to any one of the aforementioned composite materials, wherein the support member has a void volume; and the void volume of the support member is substantially filled with the macroporous cross-linked gel.

In certain embodiments, the invention relates to any one of the aforementioned composite materials, wherein the support member comprises a polymer; the support member is about 10 μm to about 5000 μm thick; the pores of the support member have an average pore diameter from about 0.1 μm to about 25 μm; and the support member has a volume porosity from about 40% to about 90%.

In certain embodiments, the invention relates to any one of the aforementioned composite materials, wherein the support member is about 10 μm to about 500 μm thick. In certain embodiments, the invention relates to any one of the aforementioned composite materials, wherein the support member is about 30 μm to about 300 μm thick. In certain embodiments, the invention relates to any one of the aforementioned composite materials, wherein the support member is about 30 μm, about 50 μm, about 100 μm, about 150 μm, about 200 μm, about 250 μm, or about 300 μm thick. In certain embodiments, the invention relates to any one of the aforementioned composite materials, wherein a plurality of support members from about 10 μm to about 500 μm thick may be stacked to form a support member up to about 5000 μm thick.

In certain embodiments, the invention relates to any one of the aforementioned composite materials, wherein the pores of the support member have an average pore diameter from about 0.1 μm to about 25 μm. In certain embodiments, the invention relates to any one of the aforementioned composite materials, wherein the pores of the support member have an average pore diameter from about 0.5 μm to about 15 μm. In certain embodiments, the invention relates to any one of the aforementioned composite materials, wherein the pores of the support member have an average pore diameter of about 0.5 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, or about 15 μm.

In certain embodiments, the invention relates to any one of the aforementioned composite materials, wherein the support member has a volume porosity from about 40% to about 90%. In certain embodiments, the invention relates to any one of the aforementioned composite materials, wherein the support member has a volume porosity from about 50% to about 80%. In certain embodiments, the invention relates to any one of the aforementioned composite materials, wherein the support member has a volume porosity of about 50%, about 60%, about 70%, or about 80%.

In certain embodiments, the invention relates to any one of the aforementioned composite materials, wherein the support member comprises a polyolefin.

In certain embodiments, the invention relates to any one of the aforementioned composite materials, wherein the support member comprises a polymeric material selected from the group consisting of polysulfones, polyethersulfones, polyphenyleneoxides, polycarbonates, polyesters, cellulose and cellulose derivatives.

In certain embodiments, the invention relates to any one of the aforementioned composite materials, wherein the support member comprises a non-woven fiberglass.

In certain embodiments, the invention relates to any one of the aforementioned composite materials, wherein the support member comprises a fibrous woven or non-woven fabric comprising a polymer; the support member is from about 10 μm to about 2000 μm thick; the pores of the support member have an average pore diameter of from about 0.1 μm to about 25 μm; and the support member has a volume porosity from about 40% to about 90%.

In certain embodiments, the invention relates to any one of the aforementioned composite materials, wherein the support member comprises a non-woven material comprising fiberglass; the support member is from about 10 μm to about 5000 μm thick; the pores of the support member have an average pore diameter of from about 0.1 μm to about 50 um; and the support member has a volume porosity from about 40% to about 90%.

### Exemplary Methods

In certain embodiments, the invention relates to a method, comprising the step of:

contacting, at a first flow rate, a first fluid with any one of the aforementioned composite materials, wherein said first fluid comprises a first mixture of stereoisomers of a compound; said first mixture consists of a first enantiomer and a second enantiomer; the first enantiomer and the second enantiomer are enantiomers of each other; and the rate of passage of the second enantiomer through the composite material is greater than the rate of passage of the first enantiomer through the composite material, thereby producing a second mixture of stereoisomers of the compound.

In certain embodiments, the invention relates to any one of the aforementioned methods, wherein the fluid flow path of the first fluid is substantially through the macropores of the composite material.

In certain embodiments, the invention relates to any one of the aforementioned methods, wherein the fluid flow path of the first fluid is substantially perpendicular to the pores of the support member.

In certain embodiments, the invention relates to a method, comprising the steps of:

contacting, at a first flow rate, a first fluid with any one of the aforementioned composite materials, wherein said first fluid comprises a first mixture of stereoisomers of a compound; said first mixture consists of a first enantiomer and a second enantiomer; the first enantiomer and the second enantiomer are enantiomers of each other; and the rate of passage of the second enantiomer through the composite material is greater than the rate of passage of the first enantiomer through the composite material, thereby producing a second mixture of stereoisomers of the compound; and

contacting the second mixture of stereoisomers of the compound with a second of the aforementioned composite materials, wherein the first composite material and the second composite material are different, thereby producing a third mixture of stereoisomers of the compound.

In certain embodiments, the invention relates to a method, comprising the step of:

contacting, at a first flow rate, a first fluid with any one of the aforementioned composite materials, wherein said first fluid comprises a first mixture of stereoisomers of a compound; said first mixture consists of a first enantiomer and a second enantiomer; the first enantiomer and the second enantiomer are enantiomers of each other; and the first enantiomer is adsorbed or absorbed onto the composite material, thereby producing a first permeate comprising the second enantiomer.

In certain embodiments, the invention relates to any one of the aforementioned methods, further comprising the step of:

contacting, at a second flow rate, a second fluid with the first enantiomer adsorbed or absorbed onto the composite material, thereby releasing the first enantiomer from the composite material and producing a second permeate comprising the first enantiomer.

In certain embodiments, the invention relates to any one of the aforementioned methods, wherein the fluid flow path of the second fluid is substantially perpendicular to the pores of the support member.

In certain embodiments, the invention relates to any one of the aforementioned methods, wherein the fluid flow path of the second fluid is substantially through the macropores of the composite material.

In certain embodiments, the invention relates to any one of the aforementioned methods, wherein the macroporous gel displays a selective interaction for the first enantiomer.

In certain embodiments, the invention relates to any one of the aforementioned methods, wherein the macroporous gel displays a specific interaction for the first enantiomer.

In certain embodiments, the invention relates to any one of the aforementioned methods, wherein the first mixture of stereoisomers of the compound is a racemic mixture.

In certain embodiments, the invention relates to any one of the aforementioned methods, wherein the first enantiomer or the second enantiomer is an active pharmaceutical ingredient (API) or drug. In certain embodiments, the invention relates to any one of the aforementioned methods, wherein the first enantiomer is an active pharmaceutical ingredient (API) or drug. In certain embodiments, the invention relates to any one of the aforementioned methods, wherein the second enantiomer is an active pharmaceutical ingredient (API) or drug.

In certain embodiments, the invention relates to any one of the aforementioned methods, wherein the first enantiomer is an active pharmaceutical ingredient (API) or drug. In certain embodiments, the invention relates to any one of the aforementioned methods, wherein the first enantiomer is selected from the group consisting of a single enantiomer of: an N-acylated amino acid, a β-adrenergic blocker, a β-agonist, a β-blocker, a 2-amidotetralin, an amino acid, an amino acid derivative, a N-derivatized amino acid, a chiral aromatic alcohol, an arylcarboxylic acid, an aryloxythiocarboxylic acid, an arylthiocarboxylic acid, a barbiturate, a benzodiazepinone, a benzodiazepine, benzoic acid 1-phenylethylamide, 1,1′-bi-2-naphthol, 1,1′-binaphthyl-2,2′-diamine, a spherical carbon cluster buckminsterfullerene, a carboxylic acid, carprofen, chlorthalidone, clenbuterol, coumachlor, a dansyl-derivatized amino acid, a dinitrophenol-derivatized amino acid, N-(3,5-dinitrobenzoyl)leucine butyl ester, a fullerene, histidine, hydroxyphenylglycine, ibuprofen, ibuprofen-1-naphthylamide, ketoprofen, a lactam, lactic acid, leucine, methyl N-(2-naphthyl)alaninate, nadolol, 1-(1-naphthyl)ethylphenylurea, an N-oxycarbonylated amino acid, phenylalanine, phenylglycine, a phosphine oxide, a phosphinic acid, a phosphonic acid, a phosphoric acid, propranolol, propranolol oxazolidin-2-one, a sulphonic acid, a sulfoxide, tryptophan, an N-undecenoyl proline derivative, and warfarin.

In certain embodiments, the invention relates to any one of the aforementioned methods, wherein the second enantiomer is an active pharmaceutical ingredient (API) or drug. In certain embodiments, the invention relates to any one of the aforementioned methods, wherein the second enantiomer is selected from the group consisting of a single enantiomer of: an N-acylated amino acid, a β-adrenergic blocker, a β-agonist, a β-blocker, a 2-amidotetralin, an amino acid, an amino acid derivative, a N-derivatized amino acid, a chiral aromatic alcohol, an arylcarboxylic acid, an aryloxythiocarboxylic acid, an arylthiocarboxylic acid, a barbiturate, a benzodiazepinone, a benzodiazepine, benzoic acid 1-phenylethylamide, 1,1′-bi-2-naphthol, 1,1′-binaphthyl-2,2′-diamine, a spherical carbon cluster buckminsterfullerene, a carboxylic acid, carprofen, chlorthalidone, clenbuterol, coumachlor, a dansyl-derivatized amino acid, a dinitrophenol-derivatized amino acid, N-(3,5-dinitrobenzoyl)leucine butyl ester, a fullerene, histidine, hydroxyphenylglycine, ibuprofen, ibuprofen-1-naphthylamide, ketoprofen, a lactam, lactic acid, leucine, methyl N-(2-naphthyl)alaninate, nadolol, 1-(1-naphthyl)ethylphenylurea, an N-oxycarbonylated amino acid, phenylalanine, phenylglycine, a phosphine oxide, a phosphinic acid, a phosphonic acid, a phosphoric acid, propranolol, propranolol oxazolidin-2-one, a sulphonic acid, a sulfoxide, tryptophan, an N-undecenoyl proline derivative, and warfarin.

In certain embodiments, the invention relates to any one of the aforementioned methods, wherein the pendant chiral moieties are human serum albumin molecules; and the first enantiomer comprises a carboxylic acid or an amino acid. In certain embodiments, the invention relates to any one of the aforementioned methods, wherein the pendant chiral moieties are human serum albumin; and the first enantiomer comprises an underivatized carboxylic acid or an underivatized amino acid.

In certain embodiments, the invention relates to any one of the aforementioned methods, wherein the pendant chiral moieties are human serum albumin molecules; and the first enantiomer comprises ibuprofen or ketoprofen.

In certain embodiments, the invention relates to any one of the aforementioned methods, wherein the pendant chiral moieties are α₁-acid glucoprotein molecules; and the first enantiomer comprises a primary amine, a secondary amine, a tertiary amine, a quaternary ammonium, an acid, an ester, a sulfoxide, an amide, or an alcohol. In certain embodiments, the invention relates to any one of the aforementioned methods, wherein the pendant chiral moieties are α₁-acid glucoprotein molecules; and the process is reverse-phase.

In certain embodiments, the invention relates to any one of the aforementioned methods, wherein the pendant chiral moieties are an aminopropyl derivative of the ergot alkaloid (+)-terguride; and the first enantiomer comprises a carboxylic acid, or a dansyl derivative of an amino acid.

In certain embodiments, the invention relates to any one of the aforementioned methods, wherein the pendant chiral moieties are β-cyclodextrin molecules; and the first enantiomer comprises chlorthalidone, histidine, D-4-hydroxyphenylglycine, phenylalanine, atenolol, or tryptophan.

In certain embodiments, the invention relates to any one of the aforementioned methods, wherein the pendant chiral moieties are L-di-n-dodecyltartrate molecules; and the first enantiomer comprises propranolol.

In certain embodiments, the invention relates to any one of the aforementioned methods, wherein the pendant chiral moieties are N-3,5-dinitrobenzoyl-L-alanine-octylester molecules; and the first enantiomer comprises lactic acid.

In certain embodiments, the invention relates to any one of the aforementioned methods, wherein the pendant chiral moieties are dimethyl-N-3,5-dinitrobenzoyl-α-amino-2,2-dimethyl-4-pentenylphosphonate molecules; and the first enantiomer comprises a β-blocker. In certain embodiments, the invention relates to any one of the aforementioned methods, wherein the pendant chiral moieties are dimethyl-N-3,5-dinitrobenzoyl-α-amino-2,2-dimethyl-4-pentenylphosphonate molecules; and the first enantiomer comprises an underivatized f3-blocker.

In certain embodiments, the invention relates to any one of the aforementioned methods, wherein the pendant chiral moieties are (3R,4S)-4-(3,5-dinitrobenzaamido)-1,2,3,4-terahydrophenanthrene molecules; and the first enantiomer comprises a 2-amidotetralin, carprofen, coumachlor, or warfarin.

In certain embodiments, the invention relates to any one of the aforementioned methods, wherein the pendant chiral moieties are N-(3,5-dinitrobenzoyl)-1,2-diaminocyclohexane molecules; and the first enantiomer comprises a fullerene. In certain embodiments, the invention relates to any one of the aforementioned methods, wherein the pendant chiral moieties are N-(3,5-dinitrobenzoyl)-1,2-diaminocyclohexane molecules; and the first enantiomer comprises spherical carbon cluster buckminsterfullerene.

In certain embodiments, the invention relates to any one of the aforementioned methods, wherein the pendant chiral moieties are (R,R)-N-3,5-dinitrobenzoyl-1,2-diphenylethane-1,2-diamine molecules or (R,R)-DNB-diphenylethanediamine molecules; and the first enantiomer comprises an underivatized aromatic alcohol.

In certain embodiments, the invention relates to any one of the aforementioned methods, wherein the pendant chiral moieties are 3,5-dinitrobenzoyl-β-lactam derivatives; and the first enantiomer comprises a N-undecenoyl proline derivative.

In certain embodiments, the invention relates to any one of the aforementioned methods, wherein the pendant chiral moieties are quaternary ammonium derivatives of 3,5-dinitrobenzoyl-leucine; and the first enantiomer is (R,S)-(±)methyl N-(2-naphthyl)alaninate.

In certain embodiments, the invention relates to any one of the aforementioned methods, wherein the pendant chiral moieties are (R)-N-(3,5-dinitrobenzoyl)leucine amide molecules; and the first enantiomer comprises a β-adrenergic blocker. In certain embodiments, the invention relates to any one of the aforementioned methods, wherein the pendant chiral moieties are (R)-N-(3,5-dinitrobenzoyl)leucine amide molecules; and the first enantiomer comprises nadolol.

In certain embodiments, the invention relates to any one of the aforementioned methods, wherein the pendant chiral moieties are N-(3,5-dinitrobenzoyl)-(1-naphthyl)glycine amide molecules; and the first enantiomer comprises a β-agonist. In certain embodiments, the invention relates to any one of the aforementioned methods, wherein the pendant chiral moieties are N-(3,5-dinitrobenzoyl)-(1-naphthyl)glycine amide molecules; and the first enantiomer comprises clenbuterol.

In certain embodiments, the invention relates to any one of the aforementioned methods, wherein the pendant chiral moieties are N-(3,5-dinitrobenzoyl)phenylglycine amide molecules; and the first enantiomer comprises a N-undecenoyl proline derivative.

In certain embodiments, the invention relates to any one of the aforementioned methods, wherein the pendant chiral moieties are N-(3,5-dinitrobenzoyl)tyrosine butylamide molecules; and the first enantiomer comprises a phosphine oxide, a sulfoxide, a lactam, a benzodiazepinone, or an amino acid derivative.

In certain embodiments, the invention relates to any one of the aforementioned methods, wherein the pendant chiral moieties are (S)-N-(3,5-dinitrobenzoyl)tyrosine derivatives; and the first enantiomer comprises ibuprofen-1 -naphthylamide, benzoic acid 1-phenylethylamide, 1-(1-naphthyl)ethylphenylurea, a sulfoxide, or propranolol oxazolidin-2-one.

In certain embodiments, the invention relates to any one of the aforementioned methods, wherein the pendant chiral moieties are N-dodecyl-4(R)-hydroxyl-L-proline molecules; and the first enantiomer comprises propranolol.

In certain embodiments, the invention relates to any one of the aforementioned methods, wherein the pendant chiral moieties are N-hexadecyl-L-hydroxyproline molecules; and the first enantiomer comprises propranolol.

In certain embodiments, the invention relates to any one of the aforementioned methods, wherein the pendant chiral moieties are N-methyl tent-butyl carbamoylated quinine molecules; and the first enantiomer comprises a N-derivatized-α-amino acid.

In certain embodiments, the invention relates to any one of the aforementioned methods, wherein the pendant chiral moieties are [N-1-[(1-naphthyl)ethyl]amido] indoline-2-carboxylic acid amide molecules; and the first enantiomer comprises a β-agonist, a β-blocker, an amino acid, an amino acid derivative, a barbiturate, or a benzodiazepine.

In certain embodiments, the invention relates to any one of the aforementioned methods, wherein the pendant chiral moieties are quinine derivatives or quinidine derivatives; and the first enantiomer comprises a N-derivatized amino acid or a carboxylic acid. In certain embodiments, the invention relates to any one of the aforementioned methods, wherein the pendant chiral moieties are quinine derivatives or quinidine derivatives; and the first enantiomer comprises suprofen, ibuprofen, or naproxen.

In certain embodiments, the invention relates to any one of the aforementioned methods, wherein the pendant chiral moieties are quinidine molecules, quinine molecules, epiquinine molecules, or epiquinidine tert-butylcarbamate molecules; and the first enantiomer comprises a N-acylated α-amino acid or a N-carbonylated α-amino acid.

In certain embodiments, the invention relates to any one of the aforementioned methods, wherein the pendant chiral moieties are quinidine derivatives or quinidine molecules; and the first enantiomer comprises ibuprofen.

In certain embodiments, the invention relates to any one of the aforementioned methods, wherein the pendant chiral moieties are quinine carbamate C₉-dimer molecules; and the first enantiomer comprises a DNP derivative of an amino acid, or a profen.

In certain embodiments, the invention relates to any one of the aforementioned methods, wherein the pendant chiral moieties are quinine carbamates or quinidine carbamates; and the first enantiomer comprises an arylcarboxylic acid, an aryloxycarboxylic acid, an arylthiocarboxylic acid, or a N-derivatized amino acid.

In certain embodiments, the invention relates to any one of the aforementioned methods, wherein the pendant chiral moieties are N-undecylenyl-L-aminoacid molecules or N-undecylenyl-L-peptide molecules; and the first enantiomer is (±)-1,1′-bi-2-naphthol or (=)-1,1′-binaphthyl-2,2′-diamine.

In certain embodiments, the invention relates to any one of the aforementioned methods, wherein the first flow rate is from about 0.1 to about 10 mL/min. In certain embodiments, the invention relates to any one of the aforementioned methods, wherein the second flow rate is from about 0.1 to about 10 mL/min. In certain embodiments, the invention relates to any one of the aforementioned methods, wherein the first flow rate or the second flow rate is about 0.1 mL/min, about 0.2 mL/min, about 0.3 mL/min, about 0.4 mL/min, about 0.5 mL/min, about 0.6 mL/min, about 0.7 mL/min, about 0.8 mL/min, about 0.9 mL/min, about 1.0 mL/min, about 1.1 mL/min, about 1.2 mL/min, about 1.3 mL/min, about 1.4 mL/min, about 1.5 mL/min, about 1.6 mL/min, about 1.7 mL/min, about 1.8 mL/min, about 1.9 mL/min, about 2.0 mL/min, about 2.5 mL/min, about 3.0 mL/min, about 4.0 mL/min, about 4.5 mL/min, about 5.0 mL/min, about 5.5 mL/min, about 6.0 mL/min, about 6.5 mL/min, about 7.0 mL/min, about 7.5 mL/min, about 8.0 mL/min, about 8.5 mL/min, about 9.0 mL/min, about 9.5 mL/min, or about 10.0 mL/min. In certain embodiments, the invention relates to any one of the aforementioned methods, wherein the first flow rate or the second flow rate is from about 0.5 mL/min to about 5.0 mL/min.

The degree of chirality is typically quantified in terms of percent enantiomeric excess (% ee) which is determined by dividing the measured specific rotation of an enantiomeric mixture by the specific rotation for the chirally pure enantiomer and multiplying by one hundred. Thus, the degree of chirality ranges from 0% ee for racemic mixtures to 100% ee for a chirally pure material. In certain embodiments, the invention relates to any one of the aforementioned methods, wherein the second mixture of stereoisomers, the third mixture of stereoisomers, the first permeate, or the second permeate has between 1% and 100% ee. In certain embodiments, the invention relates to any one of the aforementioned methods, wherein the second mixture of stereoisomers, the third mixture of stereoisomers, the first permeate, or the second permeate has between about 10 and about 90% ee, between about 20 and about 90% ee, or between about 30 and about 90% ee. In certain embodiments, the invention relates to any one of the aforementioned methods, wherein, the second mixture of stereoisomers, the third mixture of stereoisomers, the first permeate, or the second permeate has greater than about 60% ee, greater than about 70% ee, greater than about 80% ee, or greater than about 90% ee. In certain embodiments, the invention relates to any one of the aforementioned methods, wherein, the second mixture of stereoisomers, the third mixture of stereoisomers, the first permeate, or the second permeate has greater than about 92% ee, greater than about 94% ee, greater than about 96% ee, or greater than about 98% ee.

In certain embodiments, the invention relates to any one of the aforementioned methods, wherein the first fluid comprises water. In certain embodiments, the invention relates to any one of the aforementioned methods, wherein the first fluid is water. In certain embodiments, the invention relates to any one of the aforementioned methods, wherein the first fluid comprises a buffer. In certain embodiments, the invention relates to any one of the aforementioned methods, wherein the concentration of the buffer in the first fluid is from about 1 mM to about 0.1 M. In certain embodiments, the invention relates to any one of the aforementioned methods, wherein the concentration of the buffer in the first fluid is about 1 mM, about 2 mM, about 3 mM, about 4 mM, about 5 mM, about 10 mM, about 15 mM, about 20 mM, about 25 mM, about 30 mM, about 35 mM, about 40 mM, about 45 mM, about 50 mM, about 55 mM, about 60 mM, about 65 mM, about 70 mM, about 75 mM, about 80 mM, about 85 mM, about 90 mM, about 95 mM, or about 0.1 M. In certain embodiments, the invention relates to any one of the aforementioned methods, wherein the buffer is ammonium acetate, ammonium formate, ammonium nitrate, ammonium phosphate, ammonium tartrate, potassium acetate, potassium citrate, potassium formate, potassium phosphate, sodium acetate, sodium formate, sodium phosphate, or sodium tartrate.

In certain embodiments, the invention relates to any one of the aforementioned methods, wherein the first fluid comprises an organic solvent. In certain embodiments, the invention relates to any one of the aforementioned methods, wherein the organic solvent is acetonitrile, tetrahydrofuran, iso-propanol, n-propanol, ethanol, or methanol, or a mixture of any of these.

In certain embodiments, the invention relates to any one of the aforementioned methods, wherein the first fluid comprises an organic solvent and water.

In certain embodiments, the invention relates to any one of the aforementioned methods, wherein the first fluid comprises an additive. In certain embodiments, the invention relates to any one of the aforementioned methods, wherein the additive is acetic acid, triethylamine, octanoic acid, dimethyloctylamine, or disodium ethylenediaminetetraacetic acid (disodium EDTA).

In certain embodiments, the invention relates to any one of the aforementioned methods, wherein the pH of the first fluid is about 4, about 5, about 6, about 7, about 8, or about 9.

In certain embodiments, the invention relates to a method of making a composite material, comprising the steps of:

combining a monomer, a photoinitiator, a cross-linking agent, and a solvent, thereby forming a monomeric mixture; contacting a support member with the monomeric mixture, thereby forming a modified support member; wherein the support member comprises a plurality of pores extending through the support member, and the average pore diameter of the pores is about 0.1 to about 25 μm;

covering the modified support member with a polymeric sheet, thereby forming a covered support member; and

irradiating the covered support member for a period of time, thereby forming a composite material.

In certain embodiments, the invention relates to a method of making a composite material, comprising the steps of:

combining a monomer, a photoinitiator, a cross-linking agent, and a solvent, thereby forming a monomeric mixture;

stacking a plurality of support members, thereby forming a stack of support members;

contacting the stack of support members with the monomeric mixture, thereby forming a modified stack of support members; wherein a support member comprises a plurality of pores extending through the support member, and the average pore diameter of the pores is about 0.1 to about 25 μm;

covering the modified stack of support members with a polymeric sheet, thereby forming a covered stack of support members; and

irradiating the covered stack of support members for a period of time, thereby forming a composite material.

In certain embodiments, the invention relates to a method of making a composite material, comprising the steps of:

combining a monomer, a photoinitiator, a cross-linking agent, and a solvent, thereby forming a monomeric mixture;

contacting a support member with the monomeric mixture, thereby forming a modified support member; wherein the support member comprises a plurality of pores extending through the support member, and the average pore diameter of the pores is about 0.1 to about 25 μm; stacking a plurality of modified support members, thereby forming a stack of modified support members;

covering the stack of modified support members with a polymeric sheet, thereby forming a covered stack of support members; and

irradiating the stack of covered support members for a period of time, thereby forming a composite material.

In certain embodiments, the invention relates to any one of the aforementioned methods, wherein the step of stacking support members allows for thicker composite materials to be obtained. In certain embodiments, the invention relates to any one of the aforementioned methods, wherein the step of stacking support members allows for composite materials with a thickness up to about 5000 μm to be obtained.

In certain embodiments, the invention relates to any one of the aforementioned methods, further comprising the step of washing the composite material with a second solvent.

In certain embodiments, the invention relates to any one of the aforementioned methods, wherein the monomer comprises acrylamide, N-acryloxysuccinimide, butyl acrylate or methacrylate, N,N-diethylacrylamide, N,N-dimethylacrylamide, 2-(N,N-dimethylamino)ethyl acrylate or methacrylate, N-[3-(N,N-dimethylamino)propyl]methacrylamide, N,N-dimethylacrylamide, n-dodecyl acrylate, n-dodecyl methacrylate, phenyl acrylate or methacrylate, dodecyl methacrylamide, ethyl acrylate or methacrylate, 2-ethylhexyl methacrylate, hydroxypropyl methacrylate, glycidyl acrylate or methacrylate, ethylene glycol phenyl ether methacrylate, n-heptyl acrylate or methacrylate, 1-hexadecyl acrylate or methacrylate, methacrylamide, methacrylic anhydride, octadecyl acrylamide, octylacrylamide, octyl acrylate or methacrylate, propyl acrylate or methacrylate, N-iso-propylacrylamide, stearyl acrylate or methacrylate, styrene, alkylated styrene derivatives, 4-vinylpyridine, vinylsulfonic acid, N-vinyl-2-pyrrolidinone (VP), acrylamido-2-methyl-1-propanesulfonic acid, styrenesulfonic acid, alginic acid, (3-acrylamidopropyl)trimethylammonium halide, diallyldimethylammonium halide, 4-vinyl-N-methylpyridinium halide, vinylbenzyl-N-trimethylammonium halide, methacryloxyethyltrimethylammonium halide, or 2-(2-methoxy)ethyl acrylate or methacrylate.

In certain embodiments, the invention relates to any one of the aforementioned methods, wherein the photoinitiator is present in the monomeric mixture in an amount from about 0.4% (w/w) to about 2.5% (w/w) relative to the total weight of monomer.

In certain embodiments, the invention relates to any one of the aforementioned methods, wherein the photoinitiator is present in the monomeric mixture in about 0.6%, about 0.8%, about 1.0%, about 1.2%, or about 1.4% (w/w) relative to the total weight of monomer.

In certain embodiments, the invention relates to any one of the aforementioned methods, wherein the photoinitiator is selected from the group consisting of 1-[4-(2-hydroxyethoxy)-phenyl]-2-hydroxy-2-methyl-1-propane-1-one, 2,2-dimethoxy-2-phenylacetophenone, benzophenone, benzoin and benzoin ethers, dialkoxyacetophenones, hydroxyalkylphenones, and α-hydroxymethyl benzoin sulfonic esters.

In certain embodiments, the invention relates to any one of the aforementioned methods, wherein the solvent is 1,3-butanediol, di(propylene glycol) propyl ether, N,N-dimethylacetamide, di(propylene glycol) methyl ether acetate (DPMA), water, dioxane, dimethylsulfoxide (DMSO), dimethylformamide (DMF), acetone, ethanol, N-methylpyrrolidone (NMP), tetrahydrofuran (THF), ethyl acetate, acetonitrile, toluene, xylenes, hexane, N-methylacetamide, propanol, or methanol.

In certain embodiments, the invention relates to any one of the aforementioned methods, wherein the monomer and the cross-linking agent are present in the solvent in about 10% to about 45% (w/w).

In certain embodiments, the invention relates to any one of the aforementioned methods, wherein the monomer and the cross-linking agent are present in the solvent in an amount of about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40% (w/w).

In certain embodiments, the invention relates to any one of the aforementioned methods, wherein the cross-linking agent is selected from the group consisting of bisacrylamidoacetic acid, 2,2-bis[4-(2-acryloxyethoxy)phenyl]propane, 2,2-bis(4-methacryloxyphenyl)propane, butanediol diacrylate and dimethacrylate, 1,4-butanediol divinyl ether, 1,4-cyclohexanediol diacrylate and dimethacrylate, 1,10-dodecanediol diacrylate and dimethacrylate, 1,4-diacryloylpiperazine, diallylphthalate, 2,2-dimethylpropanediol diacrylate and dimethacrylate, dipentaerythritol pentaacrylate, dipropylene glycol diacrylate and dimethacrylate, N,N-dodecamethylenebisacrylamide, divinylbenzene, glycerol trimethacrylate, glycerol tris(acryloxypropyl) ether, N,N′-hexamethylenebisacrylamide, N,N′-octamethylenebisacrylamide, 1,5-pentanediol diacrylate and dimethacrylate, 1,3-phenylenediacrylate, poly(ethylene glycol) diacrylate and dimethacrylate, poly(propylene) diacrylate and dimethacrylate, triethylene glycol diacrylate and dimethacrylate, triethylene glycol divinyl ether, tripropylene glycol diacrylate or dimethacrylate, diallyl diglycol carbonate, poly(ethylene glycol) divinyl ether, N,N′-dimethacryloylpiperazine, divinyl glycol, ethylene glycol diacrylate, ethylene glycol dimethacrylate, N,N′-methylenebisacrylamide, 1,1,1-trimethylolethane trimethacrylate, 1,1,1-trimethylolpropane triacrylate, 1,1,1-trimethylolpropane trimethacrylate (TRIM-M), vinyl acrylate, 1,6-hexanediol diacrylate and dimethacrylate, 1,3-butylene glycol diacrylate and dimethacrylate, alkoxylated cyclohexane dimethanol diacrylate, alkoxylated hexanediol diacrylate, alkoxylated neopentyl glycol diacrylate, aromatic dimethacrylate, caprolactone modified neopentylglycol hydroxypivalate diacrylate, cyclohexane dimethanol diacrylate and dimethacrylate, ethoxylated bisphenol diacrylate and dimethacrylate, neopentyl glycol diacrylate and dimethacrylate, ethoxylated trimethylolpropane triacrylate, propoxylated trimethylolpropane triacrylate, propoxylated glyceryl triacrylate, pentaerythritol triacrylate, tris (2-hydroxy ethyl)isocyanurate triacrylate, di-trimethylolpropane tetraacrylate, dipentaerythritol pentaacrylate, ethoxylated pentaerythritol tetraacrylate, pentaacrylate ester, pentaerythritol tetraacrylate, caprolactone modified dipentaerythritol hexaacrylate, N,N′-methylenebisacrylamide, diethylene glycol diacrylate and dimethacrylate, trimethylolpropane triacrylate, ethylene glycol diacrylate and dimethacrylate, tetra(ethylene glycol) diacrylate, 1,6-hexanediol diacrylate, divinylbenzene, and poly(ethylene glycol) diacrylate.

In certain embodiments, the invention relates to any one of the aforementioned methods, wherein the mole percentage of cross-linking agent to monomer is about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

In certain embodiments, the invention relates to any one of the aforementioned methods, wherein the covered support member is irradiated at about 350 nm.

In certain embodiments, the invention relates to any one of the aforementioned methods, wherein the period of time is about 1 minute, about 5 minutes, about 10 minutes, about 15 minutes, about 20 minutes, about 30 minutes, about 45 minutes, or about 1 hour.

In certain embodiments, the invention relates to any one of the aforementioned methods, wherein the composite material comprises macropores.

In certain embodiments, the invention relates to any one of the aforementioned methods, wherein the average pore diameter of the macropores is less than the average pore diameter of the pores.

In certain embodiments, the invention relates to any one of the aforementioned methods, further comprising the step of modifying the macroporous gel with a chiral moiety. In certain embodiments, the chiral moiety is covalently bound to the macroporous gel. In certain embodiments, the chiral moiety is covalently bound to a linker, which is, in turn, covalently bound to the macroporous gel.

### Process Considerations

The efficiency of transport process of enantiomers through membranes can be measured by a variety of indicia.

The sorption coefficient is a thermodynamically-determined parameter defined as the ratio of the concentration in the membrane (Cₘ) to that in the solution (Cₒ), as shown below.

S=Cₘ/Cₒ

The separation factor α is calculated from the concentration of the upstream side and downstream side, and is defined as follows:

α=(Cₚ(R)/Cₚ(S)/(C_{f}(R)/C_{f}(S))

or

α=(Cₚ(S)/Cₚ(R)/(C_{f}(S)/C_{f}(R)),

where C_{f}(R) and C_{f}(S) are the concentrations of the R-enantiomer and S-enantiomer in the feed solution (solution at upstream side), respectively. Cₚ(R) and Cₚ(S) are the concentrations of the R-enantiomer and S-enantiomer in the permeate solution (solution at downstream side), respectively. The concentrations in the upstream side, C_{f}(S) and C_{f}(R), are the same in some cases. In this case, a reduces to;

α=Cₚ(S)/Cₚ(R) or Cₚ(R)/Cₚ(S).

The enantioselectivity of transport through the membrane can be divided into two factors, solubility selectivity and diffusion selectivity.

α=P(R)/P(S)=D(R)S(R)/[D(S)S(S)]

or

α=P(S)/P(R)=D(S)S(S)/[D(R)S(R)],

where D(R) and D(S) are the diffusion coefficients of the R-enantiomer and S-enantiomer, respectively. S(R) and S(S) are the solubility coefficients of the R-enantiomer and S-enantiomer, respectively.

The chiral selectivity of transport through membranes is also evaluated in terms of the enantiomeric excess (ee) of permeates. The ee value is defined as the ratio of the concentration difference over the total concentration of both enantiomers in the permeate.

ee=[Cₚ(R)−Cₚ(S)]/[Cₚ(R)+Cₚ(S)]

or

ee=[Cₚ(S)−Cₚ(R)]/[Cₚ(S)+Cₚ(R)].

When the concentrations in the feed side C_{f}(S) and C_{f}(R) are the same, the separation factor can be calculated from ee using the following equation:

α=(1+ee)/(1−ee).

In certain embodiments, the invention relates to a method that exhibits a higher binding constant for a first enantiomer than for a second enantiomer. In certain embodiments, the ratio of binding constants (binding constant first enantiomer (mM⁻¹)/binding constant second enantiomer (mM⁻¹)) is about 1.2, about 1.3, about 1.4, about 1.5, about 1.6, about 1.7, about 1.8, about 1.9, about 2.0, about 2.5, about 3.0, about 3.5, about 4.0, about 4.5, about 5.0, or greater.

In certain embodiments, the invention relates to a method that exhibits a binding constant for a first enantiomer of about 0.04 mM⁻¹ about 0.05 mM⁻¹ about 0.06 mM⁻¹ about 0.07 mM⁻¹ about 0.08 mM⁻¹ about 0.09 mM⁻¹ about 0.1 mM⁻¹ about 0.2 mM⁻¹ about 0.3 mM⁻¹ about 0.4 mM⁻¹ about 0.5 mM⁻¹ about 0.6 mM⁻¹ about 0.7 mM⁻¹ about 0.8 mM⁻¹ about 0.9 mM⁻¹ about 1.0 mM⁻¹ or greater.

In certain embodiments, the invention relates to a method that exhibits high enantioselectivity. In certain embodiments, the enantioselectivity is about 1.2, about 1.3, about 1.4, about 1.5, or greater.

In certain embodiments, the invention relates to a method that exhibits a separation factor of about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 6.0, about 7.0, about 8.0, about 9.0, about 10.0, about 11.0, about 12.0, about 13.0, about 14.0, about 15.0, about 16.0, about 17.0, about 18.0, about 19.0, about 20.0, or greater.

In certain embodiments, the invention relates to a method that exhibits a selectivity coefficient of about 3.0, about 3.2, about 3.4, about 3.6, about 3.8, about 4.0, about 4.2, about 4.4, about 4.6, about 4.8, about 5.0, or greater.

In certain embodiments, the invention relates to a method that exhibits high binding capacities. In certain embodiments, the invention relates to a method that exhibits binding capacities at 10% breakthrough of about 10 μg/mL_{membrane}, about 15 μg/mL_{membrane}, about 20 μg/mL_{membrane}, about 25 μg/mL_{membrane}, about 30 μg/mL_{membrane}, about 35 μg/mL_{membrane}, about 40 μg/mL_{membrane}, about 45, μg/mL_{membrane}, or about 50 μg/mL_{membrane}.

### EXEMPLIFICATION

The following examples are provided to illustrate the invention. It will be understood, however, that the specific details given in each example have been selected for purpose of illustration and are not to be construed as limiting the scope of the invention. Generally, the experiments were conducted under similar conditions unless noted.

### Example 1

### General Procedures

### Preparation of Composite Materials

A composite material was prepared from the monomer solutions described below and the support TR0671 B50 (Hollingsworth & Vose) using the photoinitiated polymerization according to the following general procedure. A weighed support member was placed on a poly(ethylene) (PE) sheet and a monomer or polymer solution was applied to the sample. The sample was subsequently covered with another PE sheet and a rubber roller was run over the sandwich to remove excess solution. In situ gel formation in the sample was induced by polymerization initiated by irradiation with the wavelength of, for example, 350 nm for a period time (e.g., about 10 minutes to about 30 minutes). Membrane was stored in water for 24 h and then dried at room temperature. To determine the amount of gel formed in the support, the sample was dried in an oven at 50° C. to a constant mass. The mass gain due to gel incorporation was calculated as a ratio of add on mass of the dry gel to the initial mass of the porous support.

### Analysis of Flux of Composite Materials

Water flux measurements through the composite materials were carried out after the samples had been washed with water. As a standard procedure, a sample in the form of a disk of diameter 7.8 cm was mounted on a sintered grid of 3-5 mm thickness and assembled into a cell supplied with compressed nitrogen at a controlled pressure. The cell was filled with deionised water and pressure of 100 kPa was applied. The water that passed through the composite material in a specified time was collected in a pre-weighed container and weighed. All experiments were carried out at room temperature and at atmospheric pressure at the permeate outlet. Each measurement was repeated three or more times to achieve a reproducibility of ±5%.

### Example 2

This example illustrates a method of preparing a composite material of the present invention with protein-based chiral stationary phase. The use of anchored HSA as a chiral selector on resin supports is a demonstrated approach to racemic separations.

A 25 wt-% solution was prepared by dissolving glycidyl methacrylate (GMA) monomer, butyl methacrylate (BuMe) co-monomer and trimethylolpropane trimethacrylate (TRIM-M) cross-linker in a molar ratio of 1:0.3:0.25, respectively, in a solvent mixture containing 22.4 wt-% 1,3-butanediol, 54.1 wt-% di(propylene glycol) propyl ether and 23.4 wt-% N,N′-dimethylacetamide. The photo-initiator Irgacure 2959 was added in the amount of 1 wt-% with respect to the mass of the monomers.

A composite material was prepared from the solution and the support TR0671 B50 (Hollingsworth & Vose) using the photoinitiated polymerization according to the following general procedure. A weighed support member was placed on a poly(ethylene) (PE) sheet and a monomer solution was applied the sample. The sample was subsequently covered with another PE sheet and a rubber roller was run over the sandwich to remove excess solution. In situ gel formation in the sample was induced by polymerization initiated by irradiation with the wavelength of 350 nm for the period of 10 minutes. The resulting composite material was thoroughly washed with RO and then dried at room temperature. Thereafter, membrane was placed in 10 wt-% solution of 6-aminocaproic acid in a solvent mixture containing 42 wt-% water and 58 wt-% iso-propanol for 17 hrs at room temperature. Then, membrane was washed with RO water and dried in an oven at 50° C. for 2 hrs. NHS-ester based membrane was prepared in two-steps. First step included reaction of the carboxyl-containing membrane with N,N-dicyclohexylcarbodiimide (DDC). Thus, membrane was placed in 3.3 wt-% DDC solution in iso-propanol for 17 hrs at room temperature, then; membrane was washed with iso-propanol to eliminate any excess of DDC. To yield NHS ester functionality, membrane was placed into 2 wt-% N-hydroxysuccinimide in iso-propanol for 17 hrs at room temperature. Membrane was washed with iso-propanol and stored in iso-propanol at 4° C.

Human serum albumin (HSA) immobilization process involved allowing amine groups on HSA to react with NHS-groups on the macroporous gel-membrane. This step was conducted by preparing a solution that contained 15 mg HSA in 5 mL of pH 8.3, 0.2 M carbonate buffer/0.5 M NaCl per each 1 mL of membrane. Thus, membrane was washed with cold demineralised water acidified with acetic acid to pH=3, and then with NHS-coupling buffer (0.2 M carbonate buffer containing 0.5 M NaCl, pH=8.3). The washed membrane was placed into HSA solution and left overnight at 4° C. Non-reacted groups of the macroporous gel matrix were blocked with 0.1 M TRIS buffer, pH=8.0, by placing the membrane into TRIS solution for 1 hr at room temperature. Thereafter, the coupled membrane was washed using alternative low and high pH buffers such as 0.1 M TRIS-HCl buffer, pH 8-9 and 0.1 M acetate buffer, 0.5 M NaCl pH, 4-5.

Bicinchoninic acid protein assay was used to determine HSA coupling efficiency. Spectrophotometric measurements at 562 nm were taken before and after HSA loading. The test showed HSA coupling efficiency of 80% or 12 mg HSA/mL membrane.

Membranes were characterized in terms of mass gain, water flux and chiral separation of racemic ibuprofen.

Mass Gain: In order to determine the amount of gel formed in the support, the sample was dried in an oven at 50° C. to a constant mass. The mass gain due to gel incorporation was calculated as a ratio of an add on mass of the dry gel to the initial mass of the porous support. Several samples similar to that described above were prepared and averaged to estimate the mass gain of the composite material. The substrate gained 180% of the original weight in this treatment.

Flux: Water flux measurements through the composite materials were carried out after membrane modification with 6-aminocaproic acid, assuming that further membrane modifications would not change membrane permeability. As a standard procedure, a sample in the form of a disk of diameter 7.8 cm was mounted on a sintered grid of 3-5 mm thickness and assembled into a cell supplied with compressed nitrogen at a controlled pressure. The cell was filled with deionised water and pressure of 100 kPa was applied. The water that passed through the composite material in a specified time was collected in a pre-weighed container and weighed. All experiments were carried out at room temperature and at atmospheric pressure at the permeate outlet. Each measurement was repeated three or more times to achieve a reproducibility of ±5%. The composite material produced by this method had a water flux in the range of 1,200.0-1,400.0 kg/m²hr at 100 kPa.

Separation Testing: Membranes were tested using a single layer inserted into a stainless steel disk holder attached to a typical HPLC equipment. Chromatographic studies of racemic separation of ibuprofen were carried out using 0.067 M potassium phosphate buffer containing 6 wt-% isopropanol and 5 mM octanoic acid as the mobile phase. This mobile phase was degassed under vacuum for at least 30 min prior to use. All chromatographic studies were performed at 25° C.

Waters 600E HPLC system was used for carrying out the membrane chromatographic studies. A 100 μL sample loop was used for injecting 0.03 mg/mL ibuprofen solution. The UV absorbance (at 225 nm) of the effluent stream from the Pall membrane holder and the system pressure were continuously recorded. The flow rate was 1 mL/min. Representative chromatogram obtained for the injection of racemic ibuprofen onto HSA immobilized membrane is shown in FIG. 4.

### Example 3

This example illustrates a method of preparing a composite material of the present invention with quinidine based chiral stationary phase.

A 35 wt-% solution was prepared by dissolving glycidyl methacrylate (GMA) monomer, quinidine (QD) co-monomer and trimethylolpropane trimethacrylate (TRIM-M) cross-linker in a molar ratio of 1:0.07:0.2, respectively, in a solvent mixture containing 22.6 wt-% 1,3-butanediol, 55.2 wt-% di(propylene glycol) propyl ether and 22.2 wt-% N,N′-dimethylacetamide. The photo-initiator Irgacure(R) 2959 was added in the amount of 1 wt-% with respect to the mass of the monomers. A composite material was prepared from the solution and the support TR0671 B50 (Hollingsworth & Vose) using the photoinitiated polymerization according to the general procedure describe above (Example 2). The irradiation time used was 10 minutes at 350 nm. The composite material was removed from between the polyethylene sheets, washed with RO water and placed into 0.2 M aqueous ethanol amine solution for 2 hrs to react with epoxy groups. Thereafter, membrane was washed with RO water and then with 0.1 M hydrochloric acid to protonate ammonium groups present in the membrane. Then, membrane was equilibrated and stored with 10 mM sodium phosphate buffer, pH 6.0.

Membranes were characterized in terms of mass gain, water flux and chiral separation of racemic ibuprofen as described in Example 2.

Mass Gain and Flux: Several samples similar to that described above were prepared and averaged to estimate the mass gain of the composite material. The substrate gained 170% of the original weight in this treatment. The composite material produced by this method had a water flux in the range of 3,200-3,400 kg/m²hr at 100 kPa.

Separation Testing: Membranes were pre-conditioned in 10 mM sodium acetate buffer at pH 5.5 for 30 minutes prior to use. Membranes were tested using a single layer inserted into a stainless steel disk holder attached to a typical HPLC equipment. Chromatographic studies of racemic separation of ibuprofen were carried out using 10 mM sodium phosphate buffer containing 20 wt-% acetonitrile and 1 mM octanoic acid as the mobile phase. This mobile phase was degassed under vacuum for at least 30 min prior to use. All chromatographic studies were performed at 25° C.

Waters 600E HPLC system was used for carrying out the membrane chromatographic studies. A 100 μL sample loop was used for injecting 0.03 mg/mL ibuprofen solution. The UV absorbance (at 225 nm) of the effluent stream from the membrane holder and the system pressure were continuously recorded. The flow rate was 1 mL/min.

Example 4

This example illustrates a method of preparing a composite material of the present invention with protein based chiral stationary phase.

A 25.7 wt-% solution was prepared by dissolving glycidyl methacrylate (GMA) monomer, butyl methacrylate (BuMe) co-monomer and trimethylolpropane trimethacrylate (TRIM-M) cross-linker in a molar ratio of 1:0.3:0.24, respectively, in a solvent mixture containing 26.4 wt-% 1,3-butanediol, 52.5 wt-% di(propylene glycol) propyl ether and 21.0 wt-% N,N′-dimethylacetamide. The photo-initiator Irgacure 2959 was added in the amount of 1 wt-% with respect to the mass of the monomers.

A composite material was prepared from the solution and the support TR0671 B50 (Hollingsworth & Vose) using the photoinitiated polymerization according to the following procedure. Two layers of weighed support member were placed on a poly(ethylene) (PE) sheet and a monomer or polymer solution was applied the sample. The sample was subsequently covered with another PE sheet and a rubber roller was run over the sandwich to remove excess solution. In situ gel formation in the sample was induced by polymerization initiated by irradiation with the wavelength of 350 nm for the period of 15 minutes. The resulting composite material was placed in 1 M solution of aminoacetaldehyde dimethyl acetal dissolved in N,N′-dimethylacetamide and left for 2 hrs to convert epoxy-groups to acetal-functionality groups. Thereafter, double layer membrane was thoroughly washed with RO and placed into 0.1 M HCl for 2 h to yield aldehyde groups. Then, membrane was washed with RO and DI water and kept wet for the future experiments. Human serum albumin (HSA) immobilization process involved allowing amine groups on HSA to react with aldehyde groups on the macroporous gel-membrane. This step was conducted by preparing a solution that contained 2.85 mg/mL HSA and 0.012 mg/mL sodium cyanoborohydride dissolved in 0.6 M potassium phosphate buffer of pH 7.2. Membrane was placed in HSA solution prepared as described above and rocked for 17 h at room temperature. Thereafter, membrane was washed with 0.1 M phosphate buffer (pH 7.0) for 3 times and 30 min each time. Non-reacted groups of the macroporous gel matrix were blocked with 1 M TRIS/HCl buffer at pH 7.2, by placing the membrane into 1 M TRIS solution containing 0.01 mg/mL sodium cyanoborohydride for 2 h at room temperature. As a final step membrane was equilibrated with 0.1 M sodium phosphate buffer of pH 6.0 and stored in 5% iso-propanol solution in DI water.

Bicinchoninic acid protein assay was used to determine HSA coupling efficiency. Spectrophotometric measurements at 562 nm were taken before and after HSA loading. Additional test was performed by measuring absorbance at 280 nm of 10 times diluted HSA solution before and after HSA loading. Both tests showed HSA coupling efficiency of 50% or 12.5 mg HSA/mL membrane.

Membranes were characterized in terms of mass gain, water flux and chiral separation of racemic ketoprofen.

Mass Gain and Flux: Several samples similar to that described above were prepared and averaged to estimate the mass gain of the composite material. The substrate gained 180% of the original weight in this treatment. The composite material produced by this method had a water flux in the range of 2,000-2,100 kg/m²hr at 100 kPa.

Separation Testing: Membranes were tested using a single layer of double layer membrane inserted into a stainless steel disk holder attached to a typical HPLC equipment. Chromatographic studies of racemic separation of ketoprofen were carried out using 100 mM sodium phosphate buffer containing 8 wt-% iso-propanol and 5 mM octanoic acid at pH 5.7 as the mobile phase. This mobile phase was degassed under vacuum for at least 30 min prior to use. All chromatographic studies were performed at 25° C.

Waters 600E HPLC system was used for carrying out the membrane chromatographic studies. A 100 μL sample loop was used for injecting 100 μL of 0.025 mg/mL ketoprofen solution. The UV absorbance (at 225 nm) of the effluent stream from the membrane holder and the system pressure were continuously recorded. The flow rate was 1.5 mL/min. Waters 600E HPLC system was equipped with the circular dichroism detector Jacso CD-1595. CD detection is based on an absorption difference between right and left circularly polarized light. This type of detection is intrinsically stable during temperature and solvent changes, making it gradient compatible. CD data were monitored at 260 nm.

### Example 5

This example illustrates a method of preparing a composite material of the present invention with protein based chiral stationary phase

A 19.25 wt-% solution was prepared by dissolving 2-hydroxyethyl methacrylate (HEMA) monomer, glycidyl methacrylate (GMA) co-monomer and ethylene glycol dimethacrylate (EGDA) cross-linker in a molar ratio of 1:0.55:0.80, respectively, in a solvent mixture containing 50.3 wt-% 1,3-butanediol, 41.5 wt-% di(propylene glycol) propyl ether and 8.2 wt-% DI water. The photo-initiator Irgacure 2959 was added in the amount of 1 wt-% with respect to the mass of the monomers.

A composite material was prepared from the solution and the support CRANEGLASS 330 (52-56 wt-% SiO₂) (Crane non-wovens) using photoinitiated polymerization according to the following procedure. A weighed support member was placed on a poly(ethylene) (PE) sheet and a monomer or polymer solution was applied. The support member and solution were subsequently covered with another PE sheet, then a rubber roller was run over the “sandwich” to remove excess solution. In situ gel formation in the support member was induced by irradiating the sample with 350 nm wavelength light for a period of 30 minutes. The resulting composite material was placed in a 1 M solution of aminoacetaldehyde dimethyl acetal dissolved in N,N′-dimethylacetamide and left for 2 h to convert epoxy-groups to acetal-functional groups.

Thereafter, membrane was thoroughly washed with RO and placed into 0.1 M HCl for 2 h to yield aldehyde groups. Then, membrane was washed with RO and DI water and kept wet for future experiments.

Immobilization of human serum albumin (HSA) on the membrane involved allowing amine groups on HSA to react with the aldehyde groups on the macroporous gel membrane. This step was conducted by preparing a solution that contained 3 mg/mL HSA and 0.012 mg/mL sodium cyanoborohydride dissolved in 0.6 M potassium phosphate buffer at pH 7.2. The membrane was placed in HSA solution prepared as described above and rocked for 17 h at room temperature. Thereafter, membrane was washed with 0.1 M phosphate buffer (pH 7.0) 3 times, for 30 min each time. Non-reacted groups of the macroporous gel matrix were blocked with 1 M TRIS/HCl buffer at pH 7.2 by placing the membrane into 1 M TRIS solution containing 0.01 mg/mL sodium cyanoborohydride for 2 h at room temperature. As a final step membrane was equilibrated with 0.01 M potassium phosphate buffer of pH 6.0 and stored in 5% iso-propanol solution in DI water.

A bicinchoninic acid protein assay was used to determine HSA coupling efficiency. Spectrophotometric measurements at 562 nm were taken before and after HSA loading. An additional test was performed by measuring absorbance at 280 nm of 10-times diluted HSA solution before and after HSA loading. Both tests showed HSA coupling efficiency of 40% or 9 mg HSA/mL membrane.

Membranes were characterized in terms of mass gain, thickness and chiral separation of racemic ketoprofen.

Mass Gain and Thickness: Several samples similar to that described above were prepared and averaged to estimate the mass gain of the composite material. The substrate gained 173.4% of the original weight in this treatment. Membrane thickness was measured using Mitutoyo Micrometer. Membrane thickness increased from 800 μm to 1150 μm.

Separation Testing: Membrane was tested using a 9-layer membrane packed in semi-prep cartridge, 10-mm×1-cm in a semi-prep guard column holder attached to typical HPLC equipment. Chromatographic studies of racemic separation of ketoprofen were carried out using 10 mM potassium phosphate buffer containing 10 wt-% iso-propanol and 5 mM octanoic acid at pH 5.9 as the mobile phase. This mobile phase was degassed under vacuum for at least 30 min prior to use. All chromatographic studies were performed at 25° C.

A Waters 600E HPLC system was used for carrying out the membrane chromatographic studies. A 100 μL sample loop was used for injecting 100 μL of 0.05 mg/mL ketoprofen solution. The UV absorbance (at 225 nm) of the effluent stream from the membrane holder and the system pressure were continuously recorded. The flow rate was 1.0 mL/min. The back pressure was measured using a pressure gauge at the flow rate of 1.0 mL/min. The system showed a back pressure of 25 psi. FIG. 9 shows a representative chromatogram for the injection of racemic ketoprofen onto HSA column at 1 mL/min.

Example 6

This example illustrates a method of preparing a composite material of the present invention

A 25.7 wt-% solution was prepared by dissolving glycidyl methacrylate (GMA) monomer, butyl methacrylate (BuMe) co-monomer and trimethylolpropane trimethacrylate (TRIM-M) cross-linker in a molar ratio of 1:0.3:0.24, respectively, in a solvent mixture containing 26.4 wt-% 1,3-butanediol, 52.5 wt-% di(propylene glycol) propyl ether and 21.0 wt-% N,N′-dimethylacetamide. The photo-initiator Irgacure 2959 was added in the amount of 1 wt-% with respect to the mass of the monomers.

A composite material was prepared from the solution and the support TR0671 B50 (Hollingsworth & Vose) using the photoinitiated polymerization according to the following procedure. A weighed support member as a single layer or multilayer was placed on a poly(ethylene) (PE) sheet and a monomer solution was applied to the sample. Multilayer support member means that two, three, or more support members can be placed on the top each other forming multistack support member. The monomer solution is applied to the top layer of the multistack support member, and by gravity diffuses through all layers filling support member throughout and allowing some of monomer solution remain between the layers, which, after polymerization, “glues” the layers together. Then, the sample was covered with another PE sheet and a rubber roller was run over the sandwich to remove excess solution. In situ gel formation in the sample was induced by irradiation with light of a wavelength of 350 nm for a period of 10 minutes for single-layered support members, 15 minutes for double-layered support members, or 20 minutes for triple-layered support members. The irradiation was carried out using a system containing eight 22″-long lamps on the top and the bottom of UV system, approx. 3″ spaced and emitting light at 350 nm, with the output energy of approx. 1.3-1.4 mW/cm². The irradiated sample was located approx. 10″ from the lamps. The resulting composite material was thoroughly washed with water and characterized in terms of mass gain and water flux.

Mass Gain and Flux: Several samples similar to that described above were prepared and averaged to estimate the mass gain of the composite material. The substrate gained 180% of the original weight in this treatment for single layer membrane, 190% for double-layered membranes, and 200% in the case of triple-layered support members. The composite material produced by this method had a water flux in the range of 4,100 kg/m² h-4,200 kg/m² h for single-layered membranes, 2,000 kg/m² h-2,100 kg/m² h for double-layered membranes, and 1,100 kg/m² h-1000 kg/m² h for triple-layered support members. Water flux measurements were taken at 100 kPa.

### Example 7

This example illustrates a method of preparing a composite material of the present invention with quinidine based chiral stationary phase.

A 25.0 wt-% solution was prepared by dissolving glycidyl methacrylate (GMA) monomer, quinidine (QN) co-monomer and trimethylolpropane trimethacrylate (TRIM-M) cross-linker in a molar ratio of 1:0.09:0.28, respectively, in a solvent mixture containing 23.3 wt-% 1,3-butanediol, 53.2 wt-% di(propylene glycol) propyl ether and 23.4 wt-% N,N′-dimethylacetamide. The photo-initiator Irgacure 2959 was added in the amount of 1 wt-% with respect to the mass of the monomers.

A composite material was prepared from the solution and the support CRANEGLASS 330 (52-56 wt-% SiO₂) (Crane non-wovens) using the photoinitiated polymerization according to the following procedure. A weighed support member was placed on a poly(ethylene) (PE) sheet and the monomer solution was applied. The support member was subsequently covered with another PE sheet and a rubber roller was run over the sandwich to remove excess solution. In situ gel formation was induced by irradiation with light of a wavelength of 350 nm for a period of 30 minutes. The resulting composite material was placed in a 0.5 M solution of 3,4,5-trimethoxyaniline dissolved in N,N′-dimethylacetamide and left for 5 h to react with epoxy groups, thereby introducing aromatic amino groups into the gel structure. The latter enhance π-π interactions with analyte. Thereafter, the membrane was thoroughly washed with N.N′-dimethylacetamide to remove unreacted 3,4,5-trimethoxyaniline, with RO water, and then placed into 10 mM ammonium acetate buffer at pH=6.

Membranes were characterized in terms of mass gain, thickness, and chiral separation of racemic ibuprofen.

Mass Gain and Thickness: Several samples similar to that described above were prepared and averaged to estimate the mass gain of the composite material. The substrate gained 185% of the original weight in this treatment. Membrane thickness was measured using a Mitutoyo Micrometer. Membrane thickness increased from 800 μm to 1120 μm.

Separation Testing: Membrane was tested using a 9-layer membrane packed in semi-prep cartridge, 10-mm×1-cm in a semi-prep guard column holder attached to typical HPLC equipment. Chromatographic studies of racemic separation of ibuprofen were carried out using 10 mM ammonium acetate buffer containing 50 wt-% acetonitrile at pH 5.5 as the mobile phase. This mobile phase was degassed under vacuum for at least 30 min prior to use. All chromatographic studies were performed at 25° C.

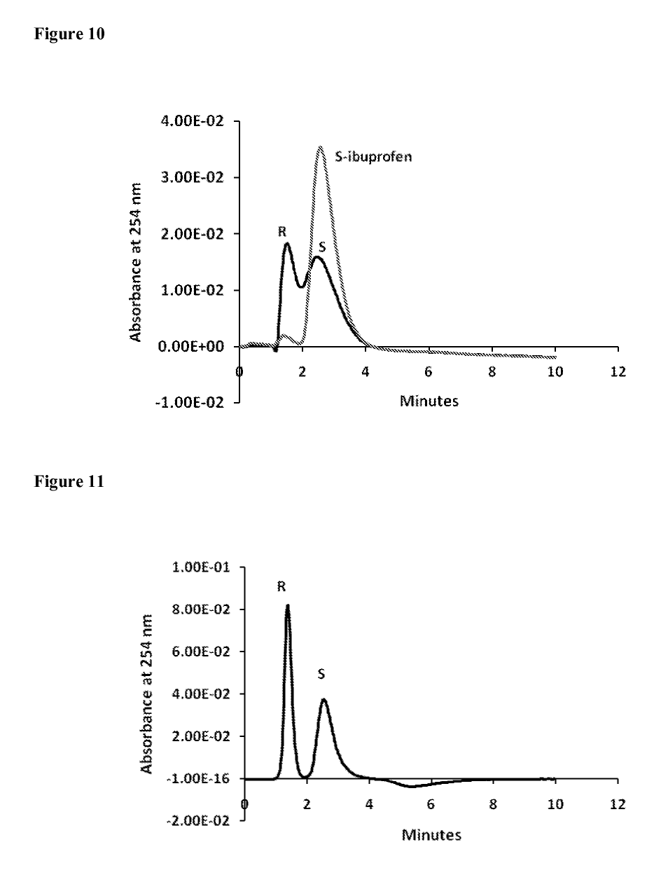

A Waters 600E HPLC system was used for carrying out the membrane chromatographic studies. A 100-μL sample loop was used for injecting 100 μL of 0.3 mg/mL ibuprofen solution. The UV absorbance (at 254 nm) of the effluent stream from the membrane holder and the system pressure were continuously recorded. The flow rate was 1.0 mL/min. The back pressure was measured using a pressure gauge at the flow rate of 1.0 mL/min. The system showed a back pressure of 45 psi. FIG. 10 shows a representative chromatogram for the injection of racemic ibuprofen onto a column with a quinidine stationary phase at 1 mL/min. Additionally, S-ibuprofen was also run through the column to verify enantiomer elution order. The second peak showed the same elution time as S-ibuprofen.

### Example 8

This example illustrates a method of preparing a composite material of the present invention with β-cyclodextrin (β-CD) based chiral stationary phase.

A 19.25 wt-% solution was prepared by dissolving 2-hydroxyethyl methacrylate (HEMA) monomer, glycidyl methacrylate (GMA) co-monomer and ethylene glycol dimethacrylate (EGDA) cross-linker in a molar ratio of 1:0.55:0.80, respectively, in a solvent mixture containing 50.3 wt-% 1,3-butanediol, 41.5 wt-% di(propylene glycol) propyl ether and 8.2 wt-% DI water. The photo-initiator Irgacure 2959 was added in the amount of 1 wt-% with respect to the mass of the monomers.

A composite material was prepared from the solution and the support CRANEGLASS 330 (52-56 wt-% SiO₂) (Crane non-wovens) using the photoinitiated polymerization according to the following procedure. A weighed support member was placed on a poly(ethylene) (PE) sheet and a monomer solution was applied the sample. The sample was subsequently covered with another PE sheet and a rubber roller was run over the sandwich to remove excess solution. In situ gel formation in the sample was induced by radiation with a wavelength of 350 nm for a period of 30 minutes. The resulting composite material was placed in a 1 M solution of hexamethylenediamine dissolved in N,N-dimethylacetamide and left for 5 h to convert epoxy-groups to ammonium containing-functionality groups. Thereafter, the membrane was thoroughly washed with N.N′-dimethylacetamide to remove excess hexamethylenediamine and later N,N-dimethylacetamide was exchanged by washing the membrane with pyridine. The β-CD stationary phase was prepared by reaction of the —NH₂ groups of the membrane gel with a solution of activated β-CD. 6 g of the β-CD was dissolved in 40 mL of dry pyridine under constant stirring. To this solution 1.8 g of 1,1′-carbonyldiimidazole (CDI) dissolved in 20 mL of pyridine, were added and stirred for 90 min at room temperature to activate the β-CD. Thereafter, the membrane (10 mL membrane volume) was placed in activated solution and left for 17 h under gentle shaking at room temperature. In order to remove the unreacted β-CD, the membrane was washed with pyridine and pyridine was later exchanged by washing the membrane with methanol.

Membranes were characterized in terms of mass gain, thickness and chiral separation of racemic atenolol.

Mass Gain and Thickness: Several samples similar to that described above were prepared and averaged to estimate the mass gain of the composite material. The substrate gained 180% of the original weight in this treatment. Membrane thickness was measured using Mitutoyo Micrometer. Membrane thickness increased from 800 μm to 1170 μm.

Separation Testing: Membrane was tested using a 9-layer membrane packed in semi-prep cartridge, 10-mm×1-cm in a semi-prep guard column holder attached to typical HPLC equipment. Chromatographic studies of racemic separation of atenolol were carried out using 95:5:0.03:0.03 (by vol) acetonitrile/methanol/acetic acid/triethylamine as the mobile phase. All chromatographic studies were performed at 25° C.

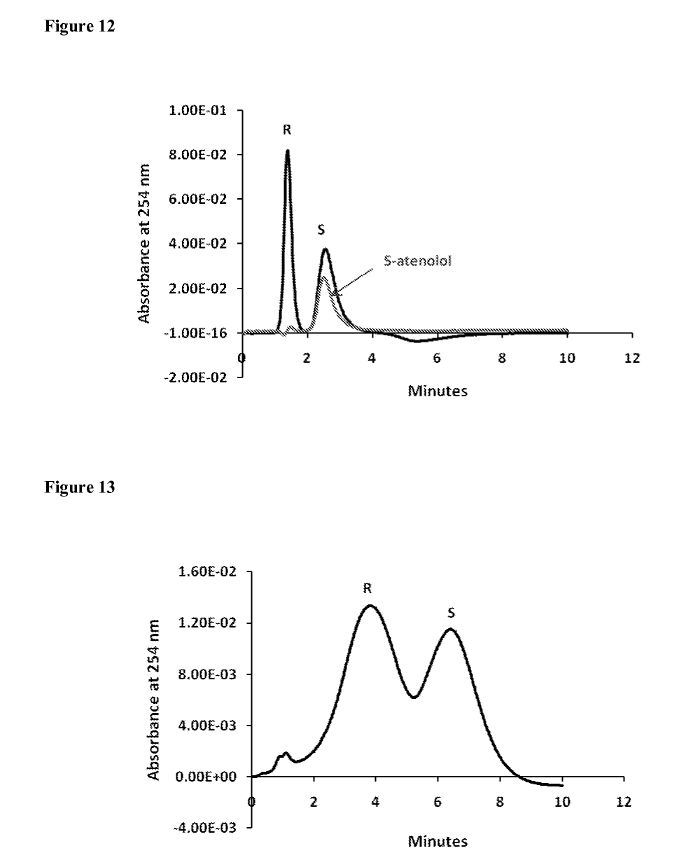

A Waters 600E HPLC system was used for carrying out the membrane chromatographic studies. A 100 μL sample loop was used for injecting 100 μL of 0.2 mg/mL atenolol solution. The UV absorbance (at 254 nm) of the effluent stream from the membrane holder and the system pressure were continuously recorded. The flow rate was 1.0 mL/min. The back pressure was measured using a pressure gauge at the flow rate of 1.0 mL/min. The system showed a back pressure of 35 psi. FIG. 11 shows representative chromatogram for the injection of racemic atenolol onto β-CD column at 1 mL/min. Additionally, S-atenolol was also run through the column to verify enantiomer elution order. Second peak showed the same elution time as S-atenolol (FIG. 12).

### Example 9

This example illustrates a method of preparing a composite material of the present invention with quinidine based chiral stationary phase.

A 25.0 wt-% solution was prepared by dissolving glycidyl methacrylate (GMA) monomer, quinidine (QN) co-monomer and trimethylolpropane trimethacrylate (TRIM-M) cross-linker in a molar ratio of 1:0.09:0.28, respectively, in a solvent mixture containing 23.3 wt-% 1,3-butanediol, 53.2 wt-% di(propylene glycol) propyl ether and 23.4 wt-% N,N′-dimethylacetamide. The photo-initiator Irgacure 2959 was added in the amount of 1 wt-% with respect to the mass of the monomers.

A composite material was prepared from the solution and the support CRANEGLASS 330 (52-56 wt-% SiO2) (Crane non-wovens) using the photoinitiated polymerization according to the following procedure. A weighed support member was placed on a poly(ethylene) (PE) sheet and the monomer solution was applied. The support member was subsequently covered with another PE sheet and a rubber roller was run over the sandwich to remove excess solution. In situ gel formation was induced by irradiation with light of a wavelength of 350 nm for a period of 30 minutes. The resulting composite material was placed in a 0.5 M solution of 2-aminofluorene dissolved in N, N-dimethylacetamide and left for 5 h to react with epoxy-groups in order to introduce aromatic amino-group in the gel structure. The later allows enhancing it-it interactions with analyte. Thereafter, the membrane was thoroughly washed with N.N′-dimethylacetamide to remove any unreacted 2-aminofluorene, with RO water, and then placed into 10 mM ammonium acetate buffer at pH=6.

Membranes were characterized in terms of mass gain, thickness, and chiral separation of racemic ibuprofen.

Mass Gain and Thickness: Several samples similar to that described above were prepared and averaged to estimate the mass gain of the composite material. The substrate gained 190% of the original weight in this treatment. Membrane thickness was measured using a Mitutoyo Micrometer. Membrane thickness increased from 800 μm to 1190 μm.

Separation Testing: Membrane was tested using a 9-layer membrane packed in semi-prep cartridge, 10-mm×1-cm in a semi-prep guard column holder attached to typical HPLC equipment. Chromatographic studies of racemic separation of ibuprofen were carried out using 10 mM ammonium acetate buffer containing 30 wt-% acetonitrile at pH 5.0 as the mobile phase. This mobile phase was degassed under vacuum for at least 30 min prior to use. All chromatographic studies were performed at 25° C.

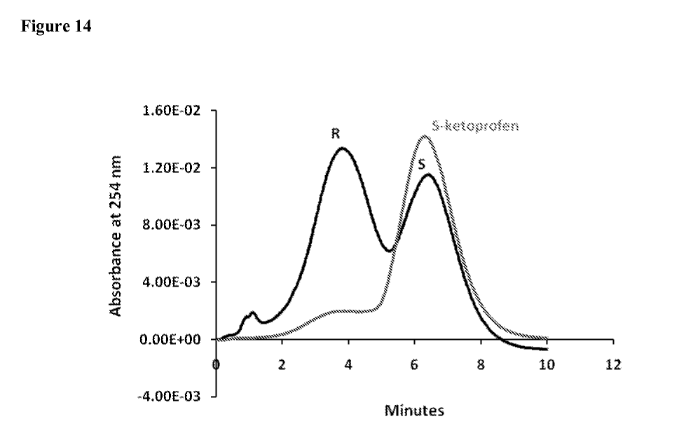

A Waters 600E HPLC system was used for carrying out the membrane chromatographic studies. A 100-μL sample loop was used for injecting 100 μL of 0.02 mg/mL ketoprofen solution. The UV absorbance (at 254 nm) of the effluent stream from the membrane holder and the system pressure were continuously recorded. The flow rate was 1.5 mL/min. A back pressure was measured using a pressure gauge at the flow rate of 1.5 mL/min. The system showed a backpressure of 90 psi. FIG. 13 shows a representative chromatogram for the injection of racemic ketoprofen onto a column with a quinidine stationary phase at 1.5 mL/min. Additionally, S-ketoprofen was also run through the column to verify enantiomer elution order. The S-enantiomer is retained longer than R-enantiomer. The second peak showed the same elution time as S-ketoprofen (FIG. 14).

### INCORPORATION BY REFERENCE

All of the U.S. patents and U.S. patent application publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A composite material, comprising:
a support member, comprising a plurality of pores extending through the support member; and
a macroporous cross-linked gel, comprising a plurality of macropores, and a plurality of pendant chiral moieties;
wherein the macroporous cross-linked gel is located in the pores of the support member; and the average pore diameter of the macropores is less than the average pore diameter of the pores.

2. The composite material of claim 1, wherein the macroporous cross-linked gel comprises a polymer derived from acrylamide, N-acryloxysuccinimide, butyl acrylate or methacrylate, N,N-diethylacrylamide, N,N-dimethylacrylamide, 2-(N,N-dimethylamino)ethyl acrylate or methacrylate, 2-(N,N-diethylamino)ethyl acrylate or methacrylate N-[3-(N,N-dimethylamino)propyl]methacrylamide, N,N-dimethylacrylamide, n-dodecyl acrylate, n-dodecyl methacrylate, phenyl acrylate or methacrylate, dodecyl methacrylamide, ethyl acrylate or methacrylate, 2-ethylhexyl acrylate or methacrylate, hydroxypropyl acrylate or methacrylate, hydroxyethyl acrylate or methacrylate, hydroxymethyl acrylate or methacrylate, glycidyl acrylate or methacrylate, ethylene glycol phenyl ether methacrylate, n-heptyl acrylate or methacrylate, 1-hexadecyl acrylate or methacrylate, methacrylamide, methacrylic anhydride, octadecyl acrylamide, octylacrylamide, octyl acrylate or methacrylate, propyl acrylate or methacrylate, N-iso-propylacrylamide, stearyl acrylate or methacrylate, styrene, alkylated styrene derivatives, 4-vinylpyridine, vinylsulfonic acid, N-vinyl-2-pyrrolidinone (VP), acrylamido-2-methyl-1-propanesulfonic acid, styrenesulfonic acid, alginic acid, (3-acrylamidopropyl)trimethylammonium halide, diallyldimethylammonium halide, 4-vinyl-N-methylpyridinium halide, vinylbenzyl-N-trimethylammonium halide, methacryloxyethyltrimethylammonium halide, or 2-(2-methoxy)ethyl acrylate or methacrylate.

3. The composite material of claim 1, wherein the pendant chiral moieties are proteins or small molecules.

4. The composite material of claim 1, wherein the pendant chiral moieties are proteins selected from the group consisting of α₁-acid glucoprotein, α-1-acid glycoprotein, albumins, amino acid oxidase apoenzyme, amyloglucosidase, antibodies, avidin, bovine serum albumin, cellobiohydrolase I, cellulose, α-chymotrypsin, DNA, DNA-cellulose, DNA-chitosan, enzymes, glucoproteins, human serum albumin, β-lactoglobulin, lysozyme, ovoglycoprotein, ovomucoid, ovotransferrin, pepsin, riboflavin binding protein, and trypsin.

5. The composite material of claim 1, wherein the pendant chiral moieties are small molecules selected from the group consisting of a single enantiomer of: an aminopropyl derivative of the ergot alkaloid terguride, copper(II) N-decyl-hydroxyproline, a cyclodextrin, a deoxycholic acid derivative, di-n-dodecyltartrate, an N,N-dimethyl carbamate of a cinchona alkaloid, dimethyl-N-3,5-dinitrobenzoyl-α-amino-2,2-dimethyl-4-pentenylphosphonate, 4-(3,5-dinitrobenzaamido)-1,2,3,4-terahydrophenanthrene, N-3,5-dinitrobenzoyl-alanine-octylester, 3,5-dinitrobenzoyl-3-amino-3-phenyl-2-(1,1-dimethylethyl)propanoate, N-(3,5-dinitrobenzoyl)-1,2-diaminocyclohexane, N-3,5-dinitrobenzoyl-1,2-diphenylethane-1,2-diamine, a 3,5-dinitrobenzoyl-β-lactam derivative, a quaternary ammonium derivative of 3,5-dinitrobenzoyl-leucine, N-(3,5-dinitrobenzoyl)leucine, N-(3,5-dinitrobenzoyl)leucine amide, N-(3,5-dinitrobenzoyl)-(1-naphthyl)glycine amide, N-3,5-dinitrobenzoyl-phenylalanine-octylester, N-(3,5-dinitrobenzoyl)phenylglycine amide, N-(3,5-dinitrobenzoyl)tyrosine butylamide, a N-(3,5-dinitrobenzoyl)tyrosine derivative, N-(3,5-dinitrobenzoyl)valine urea, a N,N-diphenyl carbamate of a chinchona alkaloid, DNB-diphenylethanediamine, N-dodecyl-4-hydroxyproline, epiquinidine tert-butylcarbamate, epiquinine, N-hexadecyl hydroxyproline, N-methyl tent-butyl carbamoylated quinine, a N-methyl-N-phenyl carbamate of a cinchona alkaloid, [N-1-[(1-naphthyl)ethyl]amido] indoline-2-carboxylic acid amide, [N-1-[(1-naphthyl)ethyl]amido] valine amide, a N-(1-naphthyl)leucine ester, N-(1-naphthyl)leucine octadecyl ester, a N-phenyl carbamate of a cinchona alkaloid, quinidine, a quinidine carbamate, quinine, a quinine carbamate, a quinine carbamate C₉-dimer, an N-undecylenyl-aminoacid, and an N-undecylenyl-peptide.

6. The composite material of claim 1, wherein the pendant chiral moieties are small molecules selected from the group consisting of: a calix[n]arene and a crown ether.

7. The composite material of claim 1, wherein the macroporous cross-linked gel has a volume porosity from about 30% to about 80%; and the macropores have an average pore diameter from about 10 nm to about 3000 nm.

8. The composite material of claim 1, wherein the support member has a void volume; and the void volume of the support member is substantially filled with the macroporous cross-linked gel.

9. The composite material of any one of claims 1-11, wherein the support member comprises a polymer; the support member is about 10 μm to about 5000 μm thick; the pores of the support member have an average pore diameter from about 0.1 μm to about 25 μm; and the support member has a volume porosity from about 40% to about 90%.

10. A method, comprising the step of:
contacting, at a first flow rate, a first fluid with a composite material of claim 1, wherein said first fluid comprises a first mixture of stereoisomers of a compound; said first mixture consists of a first enantiomer and a second enantiomer; the first enantiomer and the second enantiomer are enantiomers of each other; and the rate of passage of the second enantiomer through the composite material is greater than the rate of passage of the first enantiomer through the composite material, thereby producing a second mixture of stereoisomers of the compound.

11. The method of claim 10, wherein the first mixture of stereoisomers of the compound is a racemic mixture.

12. The method of claim 10, wherein the first enantiomer is selected from the group consisting of a single enantiomer of: an N-acylated amino acid, a β-adrenergic blocker, a β-agonist, a β-blocker, a 2-amidotetralin, an amino acid, an amino acid derivative, a N-derivatized amino acid, a chiral aromatic alcohol, an arylcarboxylic acid, an aryloxythiocarboxylic acid, an arylthiocarboxylic acid, a barbiturate, a benzodiazepinone, a benzodiazepine, benzoic acid 1-phenylethylamide, 1,1′-bi-2-naphthol, 1,1′-binaphthyl-2,2′-diamine, a spherical carbon cluster buckminsterfullerene, a carboxylic acid, carprofen, chlorthalidone, clenbuterol, coumachlor, a dansyl-derivatized amino acid, a dinitrophenol-derivatized amino acid, N-(3,5-dinitrobenzoyl)leucine butyl ester, a fullerene, histidine, hydroxyphenylglycine, ibuprofen, ibuprofen-1-naphthylamide, ketoprofen, a lactam, lactic acid, leucine, methyl N-(2-naphthyl)alaninate, nadolol, 1-(1-naphthyl)ethylphenylurea, an N-oxycarbonylated amino acid, phenylalanine, phenylglycine, a phosphine oxide, a phosphinic acid, a phosphonic acid, a phosphoric acid, propranolol, propranolol oxazolidin-2-one, a sulphonic acid, a sulfoxide, tryptophan, an N-undecenoyl proline derivative, and warfarin.

13. The method of claim 10, wherein the pendant chiral moieties are human serum albumin molecules; and the first enantiomer comprises a carboxylic acid or an amino acid.

14. The method of claim 10, wherein the pendant chiral moieties are β-cyclodextrin molecules; and the first enantiomer comprises chlorthalidone, histidine, D-4-hydroxyphenylglycine, phenylalanine, atenolol, or tryptophan.

15. The method of claim 10, wherein the pendant chiral moieties are quinine derivatives or quinidine derivatives; and the first enantiomer comprises a N-derivatized amino acid or a carboxylic acid.

16. The method of claim 10, wherein the pendant chiral moieties are quinidine molecules, quinine molecules, epiquinine molecules, or epiquinidine tert-butylcarbamate molecules; and the first enantiomer comprises a N-acylated α-amino acid or a N-carbonylated α-amino acid.

17. The method of claim 10, wherein the pendant chiral moieties are quinidine derivatives or quinidine molecules; and the first enantiomer comprises ibuprofen.

18. The method of claim 10, wherein the pendant chiral moieties are quinine carbamates or quinidine carbamates; and the first enantiomer comprises an arylcarboxylic acid, an aryloxycarboxylic acid, an arylthiocarboxylic acid, or a N-derivatized amino acid.

19. A method, comprising the step of:
contacting, at a first flow rate, a first fluid with a composite material of claim 1, wherein said first fluid comprises a first mixture of stereoisomers of a compound; said first mixture consists of a first enantiomer and a second enantiomer; the first enantiomer and the second enantiomer are enantiomers of each other; and the first enantiomer is adsorbed or absorbed onto the composite material, thereby producing a first permeate comprising the second enantiomer.
